(19) United States
(12) Patent Application Publication
(10) Pub. No.: US 2026/0206877 A1
(43) Pub. Date: Jul. 23, 2026

(54) AEROSOL-GENERATING SYSTEM

(71) Applicant: Philip Morris Products S.A., Neuchatel (CH)

(72) Inventors: Sze Chiek AW, Singapore (SG); Teck Yan CHAN, Singapore (SG); Chunzun CHEN, Xiamen (CN); Xiaojie CHEN, Xiamen (CN); Zhiwei CHEN, Xiamen (CN); Yeong Taur EOW, Singapore (SG); Jean-Luc FRINGELI, Singapore (SG); Jiafeng LI, Xiamen (CN); Seng Eng LIM, Singapore (SG); Chuah Fatt NG, Singapore (SG); Su Min SOH, Singapore (SG); Kim Poh WU, Singapore (SG); Kongfu XING, Xiamen (CN); Tenghuo ZENG, Xiamen (CN)

(73) Assignee: Philip Morris Products S.A., Neuchatel (CH)

(21) Appl. No.: 19/138,962

(22) PCT Filed: Dec. 28, 2022
(86) PCT No.: PCT/CN2022/142719

§ 371 Date: Jun. 13, 2025

(51) Int. Cl. A24F 40/60; G06F 3/041; H05B 1/02

(52) U.S. Cl. CPC A24F 40/60; G06F 3/0416; H05B 1/0252

(57) ABSTRACT

An aerosol-generating system is provided, including: a housing, wherein an arcuate portion of the housing includes an arcuate outer surface; and a touch sensor including at least one arcuate layer, a curvature of the at least one arcuate layer at least partially conforming with a curvature of the arcuate outer surface of the arcuate portion of the housing, the at least one arcuate layer being arranged within the housing such that an outward-facing surface of the at least one arcuate layer opposes an inner surface of the arcuate portion of the housing.

The present disclosure relates to an aerosol-generating system.

In accordance with a first embodiment of the present disclosure, there is provided an aerosol-generating system comprising a housing, wherein an arcuate portion of the housing comprises an arcuate outer surface. The provision of an arcuate surface on the arcuate portion of the housing may facilitate a user holding the aerosol-generating system without discomfort.

Preferably, the aerosol-generating system may further comprise a touch sensor comprising at least one arcuate layer. The provision of a touch sensor may facilitate a user providing control inputs to the system through contact by a finger of the user. Preferably, the arcuate layer may comprise at least one electrically conductive layer and/or one or more electrically conductive portions, and optionally a touch sensing area. The use of an electrically conductive layer and/or one or more electrically conductive portions may facilitate the touch sensor operating by use of capacitive touch sensing.

The arcuate layer may comprise one or more electrically conductive regions (for example, 1, 3, 5 or 6). The arcuate layer may further comprise an electrically insulating layer or film, the one or more electrically conductive regions arranged on the electrically insulating layer or film. Each one of the electrically conductive regions may have a single or a plurality of electrical connections with a controller for sensing one or more touch inputs. The controller may be configured to determine a location of a touch event based on receiving an input from a specific one of the plurality of conductive regions.

The controller for sensing one or more touch inputs may comprise one or more switches each connected to a respective electrically conductive region and a sensing capacitor. The controller may be configured to transfer charge from a respective electrically conductive region to the sensing capacitor. The controller may be configured to detect a touch event based on the voltage across the sensing capacitor, optionally after one or more predetermined time intervals.

Each one of the electrically conductive regions may form a capacitance. The capacitance of each electrically conductive region may be up to 100 pF, between 5 pF and 50 pF, between 10 pF and 30 pF, or between 15 pF and 25 pF.

The electrically conductive regions may be distributed along an axis such that movements along that axis can be determined by the controller.

The electrically conductive regions may be distributed across a two-dimensional area along a first axis and a second axis such that movements along each of the axes can be determined by the controller.

Control electronics of the aerosol-generating system may be configured to perform a function associated with a touch event at a particular electrically conductive region and/or to perform a function associated with a particular direction of movement (or gesture) performed by a user's finger.

The touch sensor may comprise an electrically conductive region surrounded by a plurality of separate regions.

Advantageously, a curvature of the arcuate layer may at least partially conform with a curvature of the arcuate outer surface of the arcuate portion of the housing. The conformance in curvature between the arcuate layer of the touch sensor and the arcuate outer surface of the arcuate portion of the housing may facilitate installation and use of the touch sensor within housings having a cylindrical cross-section (or other arcuate forms of cross-section), which may also have a limited interior volume. The aerosol-generating system may further comprise control electronics coupled to the touch sensor and configured to receive an input from the touch sensor associated with a touch event.

Preferably the aerosol-generating system may further comprise a display window having an arcuate outer surface. A curvature of the arcuate outer surface of the display window may at least partially conform with a curvature of the arcuate outer surface of the arcuate portion of the housing. The conformance in curvature may provide a clean geometry to the profile of the housing and the display window in combination, and may also facilitate a user holding the aerosol-generating system without discomfort. The arcuate outer surface of the display window may be flush with the arcuate outer surface of the arcuate portion of the housing. In this manner, the clean geometrical profile of the housing and display window in combination may be enhanced.

Conveniently, the display window may be installed in an aperture defined in the arcuate portion of the housing. The aperture and the display window may be of complementary profiles, thereby providing a matching fit therebetween.

The aerosol-generating system may further comprise a lighting assembly comprising one or more light emitting elements. The lighting assembly may be arranged within the housing to transmit light through the display window. Preferably, the light emitting elements may be electrically powered; by way of example, the light emitting elements may be in the form of one or more light emitting diodes (LEDs). LEDs are preferred due to their energy efficiency, which makes them particularly suitable where the aerosol-generating system is intended to be portable and/or handheld. The lighting assembly be arranged on a generally planar surface.

Where the aerosol-generating system includes a touch sensor having at least one arcuate layer, preferably the arcuate layer may be arranged within the housing such that an outward-facing surface of the arcuate layer opposes an inner surface of the arcuate portion of the housing. Conveniently, the arcuate layer may be arranged such that the outward-facing surface of the arcuate layer defines a convex profile. Similarly, the arcuate outer surface of the arcuate portion of the housing may define a convex profile. Preferably, the inner surface of the arcuate portion of the housing may comprise an arcuate inner surface, the arcuate inner and outer surfaces of the arcuate portion of the housing having complementary curvatures. Advantageously, the thickness of the arcuate portion of the housing, measured between the arcuate inner and outer surfaces of the arcuate portion of the housing, may be uniform at least where the outward-facing surface of the arcuate layer opposes the arcuate inner surface of the arcuate portion of the housing. Where all or part of the arcuate portion of the housing serves as a touch interface for the touch sensor, the use of such a uniform thickness may assist in providing uniform responsiveness over the surface area of the touch interface; this may be particularly relevant where the arcuate layer is part of a touch sensor operating by use of capacitive touch sensing. Preferably, the outward-facing surface of the arcuate layer may be in surface contact with the arcuate inner surface of the arcuate portion of the housing. Such surface contact may facilitate the touch sensor employing capacitive touch sensing, as well as providing a degree of structural support to the arcuate layer of the touch sensor.

Advantageously, the distance between the outward-facing surface of the arcuate layer and the arcuate outer surface of the arcuate portion of the housing, measured along a line normal to the arcuate layer, may be uniform over at least 80%, or at least 90%, or all of the surface area of the outward-facing surface of the arcuate layer. Where the arcuate outer surface of the arcuate portion of the housing serves as a touch interface for the touch sensor, providing uniformity in the distance between this surface and the outward-facing surface of the arcuate layer may assist in providing uniform responsiveness over the surface area of the touch interface; this may be particularly relevant where the arcuate layer is part of a touch sensor operating by use of capacitive touch sensing.

The arcuate portion of the housing may comprise or consist of a dielectric material. Where all or part of the arcuate portion of the housing serves as a touch interface for a capacitive touch sensor of the aerosol-generating system, the use of such a dielectric material may be beneficial as it may serve as an insulator separating a user's finger from an electrically conductive layer/region/portion of the touch sensor.

Preferably, the arcuate outer surface of the arcuate portion of the housing defines a touch interface for a user's finger.

Advantageously, at least part of the arcuate portion of the housing may define a display window, with the arcuate outer surface of the arcuate portion of the housing comprising an outer surface of the display window. Where the aerosol-generating system comprises a touch sensor having at least one arcuate layer, preferably the arcuate layer may be arranged within the housing such that an outward-facing surface of the arcuate layer opposes an inner surface of the display window. The display window may be formed of a dielectric material. The display window may form part of the arcuate portion of the housing, the display window being distinct from the remainder of the arcuate portion of the housing. Advantageously, the display window may be installed in an aperture defined in the remainder of the arcuate portion of the housing. The aperture and the display window may of complementary profiles, thereby providing a matching fit therebetween.

The aerosol-generating system further comprises a support member arranged within the housing, the arcuate layer of the touch sensor arranged over and supported on an arcuate outward-facing surface of the support member. Preferably, opposing surfaces of the arcuate layer are disposed between and in surface contact with the arcuate outward-facing surface of the support member and an arcuate inner surface of the arcuate portion of the housing. In this manner, the arcuate layer of the touch sensor is provided with structural support and increased assurance provided that the arcuate layer will maintain a fixed geometric profile during use of the aerosol-generating system. Conveniently, the support member may comprise a light guide assembly configured to guide light to the arcuate outward-facing surface of the support member. In this manner, the aerosol-generating system may facilitate integration and operation of the touch sensor and a lighting assembly as part of the aerosol-generating system.

Preferably, the arcuate layer of the touch sensor may be configured to be transmissive to the passage of light between opposing surfaces of the arcuate layer. This may be beneficial in facilitating integration and operation of the touch sensor and a lighting assembly as part of the aerosol-generating system.

As previously indicated, preferably the touch sensor may be a capacitive touch sensor. Where control electronics are coupled to the touch sensor and configured to receive an input from the touch sensor associated with a touch event, preferably the control electronics may be configured to control the supply of energy to the arcuate layer to provide an electric charge over the arcuate layer, and sense changes of electric charge of the arcuate layer associated with a touch event on the arcuate outer surface of the arcuate portion of the housing. Preferably, the control electronics may be configured to identify two dimensional user contact across the arcuate outer surface of the arcuate portion of the housing based on sensed changes of electric charge associated with the two dimensional user contact. In one example, the control electronics may be coupled to the arcuate layer so as to detect a change in capacitive coupling between different points or regions of the layer. This corresponds to a mutual capacitance mode of operation of the touch sensor, which may allow multiple simultaneous contacts on the arcuate outer surface of the housing to be separately identified and the contact locations determined. In another example, the control electronics may be coupled to the arcuate layer so as to detect a change in capacitance of a point or region of the layer with respect to ground. This corresponds to a self-capacitance mode of operation of the touch sensor.

The arcuate layer of the touch sensor may consist of or comprise copper. However, other electrically conductive materials may be employed.

The arcuate layer may be a foil. Preferably, the foil may comprise a mesh of electrically conductive filaments. The use of a meshed construction may facilitate transmission of light between opposing surfaces of the arcuate layer, which may be beneficial when integrated the touch sensor into the aerosol-generating system alongside a lighting assembly. In one example, the control electronics may be coupled to the mesh of electrically conductive filaments so as to detect a change in capacitive coupling between different ones of the electrically conductive filaments. This corresponds to a mutual capacitance mode of operation of the touch sensor. In another example, the control electronics may be coupled to the mesh of electrically conductive filaments so as to detect a change in capacitance of one or more of the filaments with respect to ground. This corresponds to a self-capacitance mode of operation of the touch sensor.

Advantageously, the aerosol-generating system may further comprise a lighting assembly comprising one or more light emitting elements, and control electronics. Where the aerosol-generating system includes a touch sensor, the lighting assembly may be coupled to a first section of the control electronics and the touch sensor coupled to a second section of the control electronics. The first and second sections of the control electronics may be co-located on a common control board. Advantageously, where the aerosol-generating system includes a touch sensor comprising at least one arcuate layer, the arcuate layer may be arranged over the lighting assembly and configured to be transmissive to the passage of light between opposing surfaces of the layer. Preferably, at least part of the arcuate portion of the housing may define a display window, wherein an outward-facing surface of the arcuate layer opposes an inner surface of the display window. The lighting assembly may be arranged within the housing such that light generated by the lighting assembly is transmitted through the display window via the arcuate layer, the display window defining a touch interface for a user. In this manner, the aerosol-generating system may facilitate integration and operation of a touch sensor and lighting assembly as part of the aerosol-generating system.

Preferably, the lighting assembly may comprise a plurality of the light emitting elements, a first lighting area and a second lighting area. Each of the first lighting area and the second lighting area may comprise one or more of the plurality of light emitting elements. Advantageously, the first lighting area may partially or wholly surround the second lighting area. The first lighting area may be arcuate in shape; for example, the first lighting area may be oval or circular in shape. Where the second lighting area is wholly or partially surrounded by the first lighting area, the shape of the second lighting area may be constrained by the first lighting area. In one example, the first lighting area is in the form of an oval ring, the ring surrounding the second lighting area, with the second lighting area being in the form of an oval. Preferably, the control electronics may be coupled to the plurality of light emitting elements and configured to selectively activate each of the first and second lighting areas to generate respective first and second light emissions. Advantageously, the control electronics may be configured to: i) selectively activate one of the first and second lighting areas to generate a first predetermined light emission conveying first data indicative of a state of the aerosol-generating system; and ii) selectively activate the other of the first and second lighting areas to generate a second predetermined light emission conveying second data indicative of a state of the aerosol-generating system, wherein the first data and the second data are different from one another.

The first and second data may be indicative of any two of: a) a power source of the aerosol-generating system containing sufficient energy to complete a single usage session; b) a power source of the aerosol-generating system containing sufficient energy to complete two, three or more usage sessions; c) a power source of the aerosol-generating system containing a level of energy below a predetermined threshold level of energy; d) selection or activation of one of a first predetermined thermal profile and a second predetermined thermal profile, in which each of the first and second predetermined thermal profiles define a heating profile for heating of the aerosol-forming substrate by an electrical heating arrangement over a usage session, the first and second predetermined thermal profiles being different to each other; e) the aerosol-generating system or part thereof being in one of a pause mode state or a reactivation state; f) selection or activation of a change in operational state of the aerosol-generating system of part thereof; g) progression through a usage session; h) progression through a pre-heating phase in which an electrical heating arrangement is heated to a predetermined target temperature; i) the aerosol-generating system or part thereof being in a locked state in which the system or part thereof is prohibited from generating aerosol; j) the aerosol-generating system or part thereof being in an unlocked state in which the system or part thereof is permitted to generate aerosol; k) an entered PIN number for unlocking the system or part thereof such that it is permitted to generate aerosol and/or an order of a PIN number in a sequence to be entered for unlocking the system or part thereof such that it is permitted to generate aerosol; l) a type of a plurality of aerosol-generating articles being detected by the system or part thereof; m) the aerosol-generating system or part thereof being too hot to permit aerosol-generation; and n) the aerosol-generating system or part thereof being too cold to permit aerosol-generation.

Preferably, where the aerosol-generating system includes a touch sensor comprising at least one arcuate layer, with control electronics coupled to the touch sensor, the arcuate layer of the touch sensor may be detachably coupled to an interface of the control electronics. The arcuate layer may comprise a push-fit connector for detachable coupling of the arcuate layer to the interface of the control electronics.

The housing may be an elongate housing having a sidewall extending in a longitudinal direction, wherein the arcuate portion of the housing forms all or part of the sidewall.

The aerosol-generating system may comprise an aerosol-generating device for generating an inhalable aerosol from an aerosol-forming substrate.

The aerosol-generating system may comprise a charging device for a power source of an aerosol-generating device, wherein the charging device is configured for coupling to the aerosol-generating device. The aerosol-generating system may comprise both the charging device and the aerosol-generating device.

Where the aerosol-generating system comprises a touch sensor coupled to control electronics, preferably the control electronics may comprise: a microcontroller comprising a processor, memory and input-output means, and a touch sensor driver as a separate component to the microcontroller. The touch sensor driver may be communicatively coupled with the microcontroller via the input-output means. The touch sensor driver may be electrically coupled with the touch sensor. Preferably, the touch sensor driver may be configured to detect a touch event based on one or more signals from the touch sensor. The touch sensor driver may be configured to process the one or more signals from the touch sensor and output data indicative of a touch event to the microcontroller. The microcontroller may be configured to process the data indicative of a touch event and in response execute one or more functions of the aerosol-generating system.

Where the aerosol-generating system comprises a touch sensor coupled to control electronics, preferably the control electronics may comprise: a microcontroller comprising a processor, memory, input-output means and touch sensing circuitry integrated into the microcontroller. The touch sensing circuitry may be electrically coupled with the touch sensor. Preferably, the touch sensing circuitry may be configured to output a signal indicative of a touch event based on one or more signals from the touch sensor. The touch sensing circuitry may be configured to output the signal indicative of a touch event by charging a sampling capacitor to a voltage indicative of a touch event. The microcontroller may be configured to process the output signal indicative of a touch event and in response execute one or more functions of the aerosol-generating system.

Where the aerosol-generating system comprises a touch sensor coupled to control electronics, preferably the control electronics may be configured to receive a plurality of inputs from the touch sensor. The plurality of inputs may be received via at least two electrically conductive portions and/or at least two touch sensing areas of the touch sensor. Advantageously, the control electronics may be configured to detect a two-dimensional touch event based on the plurality of inputs.

The aerosol-generating system may comprise a microcontroller comprising a processor, memory and input-output means; and an LED driver as a separate component to the microcontroller. The LED driver may be communicatively coupled with the microcontroller via the input-output means, and the LED driver configured to control a plurality of LEDs. Each one of the plurality of LEDs may be connected to a row pin and a column pin of the LED driver. The LED driver may comprise a plurality of row pins and a plurality of column pins, each one of the row pins connected to a plurality of LEDs, and each one of the column pins connected to a plurality of LEDS. The LED driver may be configured to illuminate each one of the plurality of LEDs by enabling the row pin and the column pin connected to the respective LED. The LED driver may be configured to illuminate a selection of the plurality of LEDs sequentially within a given time period. The LED driver may be configured to illuminate a selection of the plurality of LEDs sequentially within a given time period such that it appears that the selection of LEDs are illuminated at the same time.

The aerosol-generating system may comprise a microcontroller comprising a processor, memory and input-output means, and an LED driver integrated into the microcontroller. The LED driver may be configured to control a plurality of LEDs via the input-output means. The input-output means may comprise a plurality of row pins and a plurality of column pins, wherein each one of the plurality of LEDs is connected to a row pin and a column pin of the input-output means. The input-output means may comprise a plurality of row pins and a plurality of column pins, each one of the row pins connected to a plurality of LEDs, and each one of the column pins connected to a plurality of LEDS. The LED driver may be configured to illuminate each one of the plurality of LEDs by enabling the row pin and the column pin connected to the respective LED. The LED driver may be configured to illuminate a selection of the plurality of LEDs sequentially within a given time period. The LED driver may be configured to illuminate a selection of the plurality of LEDs sequentially within a given time period such that it appears that the selection of LEDs are illuminated at the same time.

As used herein, the term “aerosol-generating device” is used to describe a device that interacts with an aerosol-forming substrate to generate an aerosol. Preferably, the aerosol-generating device is a smoking device that interacts with an aerosol-forming substrate to generate an aerosol that is directly inhalable into a user's lungs thorough the user's mouth.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-forming substrate” refers to a substrate consisting of or comprising an aerosol-forming material that is capable of releasing volatile compounds upon heating to generate an aerosol.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former.

As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

In other examples, the housing may comprise a portion and outer surface thereof which are other than arcuate. By way of example, the housing may comprise a planar portion having a planar outer surface. Similarly, in other examples, the touch sensor may comprise one or more layers which are other than arcuate. By way of example, the one or more layers may be planar.

The invention is defined in the claims. However, below there is provided a non-exhaustive list of non-limiting examples. Any one or more of the features of these examples may be combined with any one or more features of another example, embodiment, or aspect described herein.

Example Ex1: An aerosol-generating system comprising:
a housing, wherein an arcuate portion of the housing comprises an arcuate outer surface.

Example Ex2: An aerosol-generating system according to Ex1, further comprising:
a touch sensor comprising at least one arcuate layer.

Example Ex2A: An aerosol-generating system according to Ex2, wherein the arcuate layer comprises at least one electrically conductive layer and/or one or more electrically conductive portions, and optionally a touch sensing area.

Example Ex2B: An aerosol-generating system according to either one of Ex2 or Ex2A, wherein the arcuate layer comprises one or more electrically conductive regions (for example, 1, 3, 5 or 6).

Example Ex2C: An aerosol-generating system according to Ex2B, wherein the arcuate layer further comprises an electrically insulating layer or film, the one or more electrically conductive regions arranged on the electrically insulating layer or film.

Example Ex2D: An aerosol-generating system according to either one of Ex2B or Ex2C, wherein the touch sensor comprises an electrically conductive region surrounded by a plurality of separate regions.

Example Ex2E: An aerosol-generating system according to Ex2 and optionally any one of Ex2A to Ex2D, wherein a curvature of the arcuate layer at least partially conforms with a curvature of the arcuate outer surface of the arcuate portion of the housing.

Example Ex3: An aerosol-generating system according to any one of Ex2 to Ex2E, further comprising control electronics coupled to the touch sensor and configured to receive an input from the touch sensor associated with a touch event.

Example Ex3A: An aerosol-generating system according to Ex3 when dependent on either one of Ex2B or Ex2C, wherein each one of the electrically conductive regions has a single or a plurality of electrical connections with the control electronics for sensing one or more touch inputs.

Example Ex3B: An aerosol-generating system according to Ex3A, wherein the control electronics are configured to determine a location of a touch event based on receiving an input from a specific one of the plurality of conductive regions.

Example Ex3C: An aerosol-generating system according to any one of Ex3 (when dependent on either one of Ex2B or Ex2C) to Ex3B, wherein the electrically conductive regions are distributed along an axis such that movements along that axis can be determined by the control electronics.

Example Ex3D: An aerosol-generating system according to any one of Ex3 (when dependent on either one of Ex2B or Ex2C) to Ex3C, wherein the electrically conductive regions are distributed across a two-dimensional area along a first axis and a second axis such that movements along each of the axes can be determined by the control electronics.

Example Ex3E: An aerosol-generating system according to any one of Ex3 (when dependent on either one of Ex2B or Ex2C) to Ex3D, wherein the control electronics are configured to perform a function associated with a touch event at a particular electrically conductive region and/or to perform a function associated with a particular direction of movement (or gesture) performed by a user's finger.

Example Ex4: An aerosol-generating system according to any one of Ex1 to Ex3E, further comprising a display window having an arcuate outer surface.

Example Ex4A: An aerosol-generating system according to Ex4, wherein a curvature of the arcuate outer surface of the display window at least partially conforms with a curvature of the arcuate outer surface of the arcuate portion of the housing, and optionally wherein the arcuate outer surface of the display window is flush with the arcuate outer surface of the arcuate portion of the housing.

Example Ex5: An aerosol-generating system according to Ex4 or Ex4A, wherein the display window is installed in an aperture defined in the arcuate portion of the housing.

Example Ex6: An aerosol-generating system according to any one of Ex4 to Ex5, further comprising a lighting assembly comprising one or more light emitting elements, the lighting assembly arranged within the housing to transmit light through the display window.

Example Ex6A: An aerosol-generating system according to Ex6, wherein the lighting assembly comprises a substantially planar surface having the one or more light emitting elements arranged thereon.

Example Ex7: An aerosol-generating system according to Ex2 or any Example dependent thereon, wherein the arcuate layer is arranged within the housing such that an outward-facing surface of the arcuate layer opposes an inner surface of the arcuate portion of the housing.

Example Ex8: An aerosol-generating system according to Ex7, wherein the arcuate layer is arranged such that the outward-facing surface of the arcuate layer defines a convex profile.

Example Ex9: An aerosol-generating system according to either one of Ex7 or Ex8, wherein the arcuate outer surface of the arcuate portion of the housing defines a convex profile.

Example Ex10: An aerosol-generating system according to any one of Ex7 to Ex9, wherein the inner surface of the arcuate portion of the housing comprises an arcuate inner surface, the arcuate inner and outer surfaces of the arcuate portion of the housing having complementary curvatures.

Example Ex11: An aerosol-generating system according to Ex10, wherein the thickness of the arcuate portion of the housing, measured between the arcuate inner and outer surfaces of the arcuate portion of the housing, is uniform at least where the outward-facing surface of the arcuate layer opposes the arcuate inner surface of the arcuate portion of the housing.

Example Ex12: An aerosol-generating system according to either one of Ex10 or Ex11, wherein the outward-facing surface of the arcuate layer is in surface contact with the arcuate inner surface of the arcuate portion of the housing.

Example Ex13: An aerosol-generating system according to any one of Ex7 to Ex12, wherein the distance between the outward-facing surface of the arcuate layer and the arcuate outer surface of the arcuate portion of the housing, measured along a line normal to the arcuate layer, is uniform over at least 80%, or at least 90%, or all of the surface area of the outward-facing surface of the arcuate layer.

Example Ex14: An aerosol-generating system according to any one of Ex1 to Ex13, wherein the arcuate portion of the housing comprises or consists of a dielectric material.

Example Ex15: An aerosol-generating system according to any one of Ex7 to Ex14, wherein the arcuate outer surface of the arcuate portion of the housing defines a touch interface for a user's finger.

Example Ex16: An aerosol-generating system according to any one of Ex7 to Ex15, wherein at least part of the arcuate portion of the housing defines a display window, wherein the arcuate outer surface of the arcuate portion of the housing comprises an outer surface of the display window.

Example Ex17: An aerosol-generating system according to Ex16, wherein the display window is formed of a dielectric material.

Example Ex18: An aerosol-generating system according to either one of Ex16 or Ex17, wherein the display window forms part of the arcuate portion of the housing, the display window being distinct from the remainder of the arcuate portion of the housing.

Example Ex19: An aerosol-generating system according to Ex18, wherein the display window is installed in an aperture defined in the remainder of the arcuate portion of the housing.

Example Ex20: An aerosol-generating system according to any one of Ex7 to Ex19, further comprising a support member arranged within the housing, the arcuate layer arranged over and supported on an arcuate outward-facing surface of the support member.

Example Ex21: An aerosol-generating system according to Ex20, wherein opposing surfaces of the arcuate layer are disposed between and in surface contact with the arcuate outward-facing surface of the support member and an arcuate inner surface of the arcuate portion of the housing.

Example Ex22: An aerosol-generating system according to either one of Ex20 or Ex21, wherein the support member comprises a light guide assembly configured to guide light to the arcuate outward-facing surface of the support member.

Example Ex23: An aerosol-generating system according to any one Ex7 to Ex22, wherein the arcuate layer is configured to be transmissive to the passage of light between opposing surfaces of the arcuate layer.

Example Ex24: An aerosol-generating system according to any one of Ex2 or any Example dependent thereon, wherein the touch sensor is a capacitive touch sensor.

Example Ex25: An aerosol-generating system according to Ex3 in combination with Ex24, wherein the control electronics is configured to:
control the supply of energy to the arcuate layer to provide an electric charge over the arcuate layer; and
sense changes of electric charge of the arcuate layer associated with a touch event on the arcuate outer surface of the arcuate portion of the housing.

Example Ex26: An aerosol-generating system according to Ex25, wherein the control electronics is configured to identify two dimensional user contact across the arcuate outer surface of the arcuate portion of the housing based on sensed changes of electric charge associated with the two dimensional user contact.

Example Ex27: An aerosol-generating system according to any one of Ex24 to Ex26, wherein the control electronics is coupled to the arcuate layer so as to detect a change in capacitive coupling between different points or regions of the layer.

Example Ex28: An aerosol-generating system according to any one of Ex24 to Ex27, wherein the control electronics is coupled to the arcuate layer so as to detect a change in capacitance of a point or region of the layer with respect to ground.

Example Ex29: An aerosol-generating system according to any one of Ex2 or any Example dependent thereon, wherein the arcuate layer consists of or comprises copper.

Example Ex30: An aerosol-generating system according to any one of Ex2 or any Example dependent thereon, wherein the arcuate layer is a foil.

Example Ex31: An aerosol-generating system according to Ex30, wherein the foil comprises a mesh of electrically conductive filaments.

Example Ex32: An aerosol-generating system according to Ex31, wherein the control electronics is coupled to the mesh of electrically conductive filaments so as to detect a change in capacitive coupling between different ones of the electrically conductive filaments.

Example Ex33: An aerosol-generating system according to either one of Ex31 or Ex32, wherein the control electronics is coupled to the mesh of electrically conductive filaments so as to detect a change in capacitance of one or more of the filaments with respect to ground.

Example Ex34: An aerosol-generating system according to any one of Ex1 to Ex33 further comprising a lighting assembly comprising one or more light emitting elements, and control electronics.

Example Ex35: An aerosol-generating system according to Ex2 in combination with Ex34, wherein the lighting assembly is coupled to a first section of the control electronics and the touch sensor is coupled to a second section of the control electronics.

Example Ex36: An aerosol-generating system according to Ex35, wherein the first and second sections of the control electronics are co-located on a common control board.

Example Ex37: An aerosol-generating system according to Ex2 in combination with any one of Ex34 to Ex36, wherein the arcuate layer is arranged over the lighting assembly and configured to be transmissive to the passage of light between opposing surfaces of the layer.

Example Ex38: An aerosol-generating system according to Ex37, wherein at least part of the arcuate portion of the housing defines a display window, wherein an outward-facing surface of the arcuate layer opposes an inner surface of the display window, the lighting assembly arranged within the housing such that light generated by the lighting assembly is transmitted through the display window via the arcuate layer, the display window defining a touch interface for a user.

Example Ex39: An aerosol-generating system according to any one of Ex34 to Ex38, wherein the lighting assembly comprises a plurality of the light emitting elements, a first lighting area and a second lighting area, each of the first lighting area and the second lighting area comprising one or more of the plurality of light emitting elements.

Example Ex40: An aerosol-generating system according to Ex39, wherein the first lighting area partially or wholly surrounds the second lighting area.

Example Ex41: An aerosol-generating system according to either one of Ex39 or Ex40, wherein the control electronics is coupled to the plurality of light emitting elements and configured to selectively activate each of the first and second lighting areas to generate respective first and second light emissions.

Example Ex42: An aerosol-generating system according to any one of Ex39 to Ex41, wherein the control electronics is configured to:
i) selectively activate one of the first and second lighting areas to generate a first predetermined light emission conveying first data indicative of a state of the aerosol-generating system;
and
ii) selectively activate the other of the first and second lighting areas to generate a second predetermined light emission conveying second data indicative of a state of the aerosol-generating system, wherein the first data and the second data are different from one another.

Example Ex43: An aerosol-generating system according to Ex42, wherein the first and second data are indicative of any two of:
a) a power source of the aerosol-generating system containing sufficient energy to complete a single usage session;
b) a power source of the aerosol-generating system containing sufficient energy to complete two, three or more usage sessions;
c) a power source of the aerosol-generating system containing a level of energy below a predetermined threshold level of energy;
d) selection or activation of one of a first predetermined thermal profile and a second predetermined thermal profile, in which each of the first and second predetermined thermal profiles define a heating profile for heating of the aerosol-forming substrate by an electrical heating arrangement over a usage session, the first and second predetermined thermal profiles being different to each other;
e) the aerosol-generating system or part thereof being in one of a pause mode state or a reactivation state;
f) selection or activation of a change in operational state of the aerosol-generating system or part thereof;
g) progression through a usage session;
h) progression through a pre-heating phase in which an electrical heating arrangement is heated to a predetermined target temperature;
i) the aerosol-generating system or part thereof being in a locked state in which the system or part thereof is prohibited from generating aerosol;
j) the aerosol-generating system or part thereof being in an unlocked state in which the system or part thereof is permitted to generate aerosol;
k) an entered PIN number for unlocking the system or part thereof such that it is permitted to generate aerosol and/or an order of a PIN number in a sequence to be entered for unlocking the system or part thereof such that it is permitted to generate aerosol;
l) a type of a plurality of aerosol-generating articles being detected by the system or part thereof;
m) the aerosol-generating system or part thereof being too hot to permit aerosol-generation; and
n) the aerosol-generating system or part thereof being too cold to permit aerosol-generation.

Example Ex44: An aerosol-generating system according to any one of Ex3 to Ex3E or Ex7 to Ex43, wherein the arcuate layer is detachably coupled to an interface of the control electronics.

Example Ex45: An aerosol-generating system according to Ex44, wherein the arcuate layer comprises a push-fit connector for detachable coupling of the arcuate layer to the interface of the control electronics.

Example Ex46: An aerosol-generating system according to any one of Ex1 to Ex45, wherein the housing is an elongate housing having a sidewall extending in a longitudinal direction, wherein the arcuate portion of the housing forms all or part of the sidewall.

Example Ex47: An aerosol-generating system according to any one of Ex1 to Ex46, wherein the aerosol-generating system comprises an aerosol-generating device for generating an inhalable aerosol from an aerosol-forming substrate.

Example Ex47A: An aerosol-generating system according to any one of Ex1 to Ex47, wherein the aerosol-generating system comprises a charging device for a power source of an aerosol-generating device, wherein the charging device is configured for coupling to the aerosol-generating device.

Example Ex48: An aerosol-generating system according to Ex3 or any Example dependent thereon, wherein the control electronics comprises:
a microcontroller comprising a processor, memory and input-output means; and
a touch sensor driver as a separate component to the microcontroller;
wherein the touch sensor driver is communicatively coupled with the microcontroller via the input-output means, and the touch sensor driver is electrically coupled with the touch sensor.

Example Ex48A: An aerosol-generating system according to Ex48, wherein the touch sensor driver is configured to detect a touch event based on one or more signals from the touch sensor.

Example Ex48B: An aerosol-generating system according to Ex48A, wherein the touch sensor driver is configured to process the one or more signals from the touch sensor and output data indicative of a touch event to the microcontroller.

Example Ex48C: An aerosol-generating system according to Ex48B, wherein the microcontroller is configured to process the data indicative of a touch event and in response execute one or more functions of the aerosol-generating system.

Example Ex49: An aerosol-generating system according to Ex3 or any Example dependent thereon, wherein the control electronics comprises:
a microcontroller comprising a processor, memory, input-output means and touch sensing circuitry integrated into the microcontroller;
wherein the touch sensing circuitry is electrically coupled with the touch sensor.

Example Ex49A: An aerosol-generating system according to Ex49, wherein the touch sensing circuitry is configured to output a signal indicative of a touch event based on one or more signals from the touch sensor.

Example Ex49B: An aerosol-generating system according to Ex49A, wherein the touch sensing circuitry is configured to output the signal indicative of a touch event by charging a sampling capacitor to a voltage indicative of a touch event.

Example Ex49C: An aerosol-generating system according to either one of Ex49A or Ex49B, wherein the microcontroller is configured to process the output signal indicative of a touch event and in response execute one or more functions of the aerosol-generating system.

Example Ex50: An aerosol-generating system according to Ex3 or any Example dependent thereon, wherein the control electronics is configured to receive a plurality of inputs from the touch sensor, and optionally wherein the plurality of inputs are received via at least two electrically conductive portions and/or at least two touch sensing areas of the touch sensor.

Example Ex50A: An aerosol-generating system according to Ex50, wherein the control electronics is configured to detect a two-dimensional touch event based on the plurality of inputs.

Example Ex51: An aerosol-generating system according to any one of Ex1 to Ex50A, further comprising:
a microcontroller comprising a processor, memory and input-output means; and
an LED driver as a separate component to the microcontroller;
wherein the LED driver is communicatively coupled with the microcontroller via the input-output means, and the LED driver is configured to control a plurality of LEDs.

Example Ex51A: An aerosol-generating system according to Ex51, wherein each one of the plurality of LEDs is connected to a row pin and a column pin of the LED driver.

Example Ex51B: An aerosol-generating system according to Ex51 or Ex51A, wherein the LED driver comprises a plurality of row pins and a plurality of column pins, and each one of the row pins is connected to a plurality of LEDs, and each one of the column pins is connected to a plurality of LEDS.

Example Ex51C: An aerosol-generating system according to Ex51B, wherein the LED driver is configured to illuminate each one of the plurality of LEDs by enabling the row pin and the column pin connected to the respective LED.

Example Ex51D: An aerosol-generating system according to Ex51C, wherein the LED driver is configured to illuminate a selection of the plurality of LEDs sequentially within a given time period.

Example Ex51E: An aerosol-generating system according to Ex51D, wherein the LED driver is configured to illuminate a selection of the plurality of LEDs sequentially within a given time period such that it appears that the selection of LEDs are illuminated at the same time.

Example Ex52: An aerosol-generating system according to any one of Ex1 to Ex51E, further comprising:
a microcontroller comprising a processor, memory and input-output means and an LED driver integrated into the microcontroller;
wherein the LED driver is configured to control a plurality of LEDs via the input-output means.

Example Ex52A: An aerosol-generating system according to Ex52, wherein the input-output means comprises a plurality of row pins and a plurality of column pins, wherein each one of the plurality of LEDs is connected to a row pin and a column pin of the input-output means.

Example Ex52B: An aerosol-generating system according to either one of Ex52 or Ex52A, wherein the input-output means comprises a plurality of row pins and a plurality of column pins, and each one of the row pins is connected to a plurality of LEDs, and each one of the column pins is connected to a plurality of LEDS.

Example Ex52C: An aerosol-generating system according to Ex52B, wherein the LED driver is configured to illuminate each one of the plurality of LEDs by enabling the row pin and the column pin connected to the respective LED.

Example Ex52D: An aerosol-generating system according to Ex52C, wherein the LED driver is configured to illuminate a selection of the plurality of LEDs sequentially within a given time period.

Example Ex52E: An aerosol-generating system according to Ex52D, wherein the LED driver is configured to illuminate a selection of the plurality of LEDs sequentially within a given time period such that it appears that the selection of LEDs are illuminated at the same time.

Examples will now be further described with reference to the figures in which:

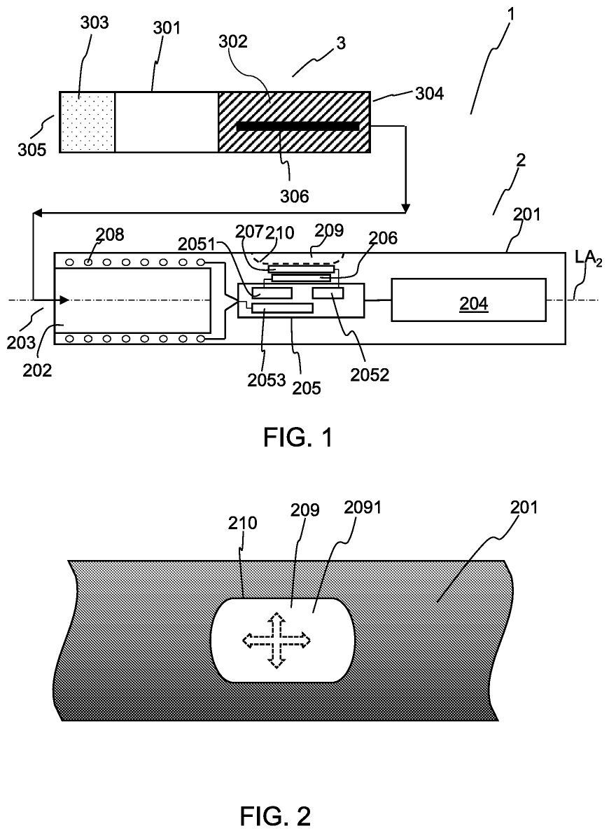

FIG. 1 shows a schematic illustration of a first embodiment of an aerosol-generating system according to the present disclosure.

FIG. 2 shows a schematic illustration of a touch interface defined by a display window of an aerosol-generating device of the aerosol-generating system of FIG. 1.

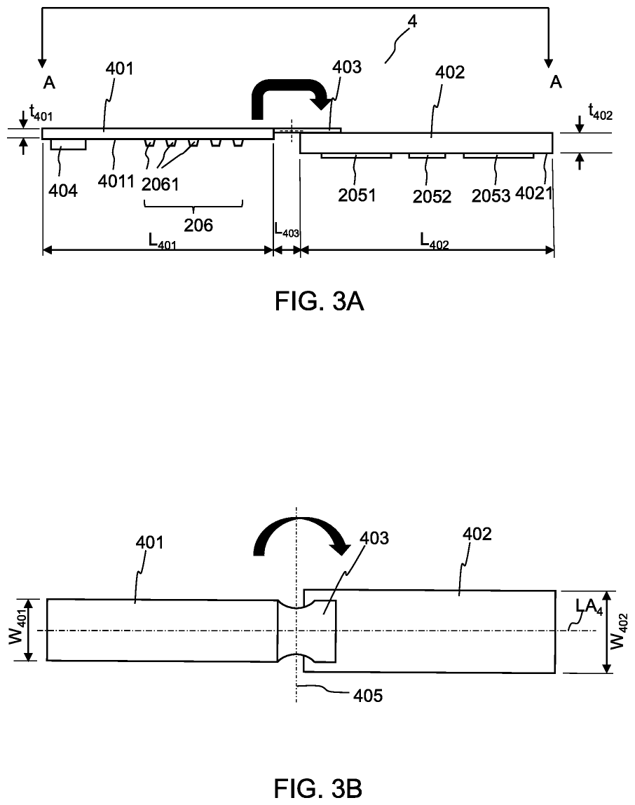

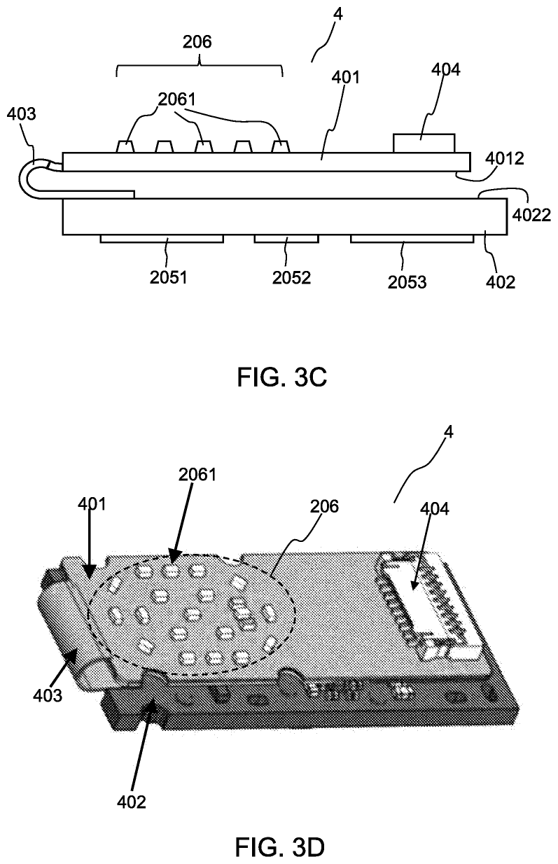

FIG. 3A shows a schematic side elevation illustration of a first embodiment of a control board assembly according to the present disclosure, the control board assembly being in an unfolded state.

FIG. 3B shows a schematic plan illustration of the control board assembly of FIG. 3A, in the direction of A-A of FIG. 3A.

FIG. 3C shows a schematic side elevation illustration of the control board assembly of FIGS. 3A and 3B after transition from the unfolded state to a folded state.

FIG. 3D shows a schematic perspective illustration from above of the control board assembly of FIG. 3C.

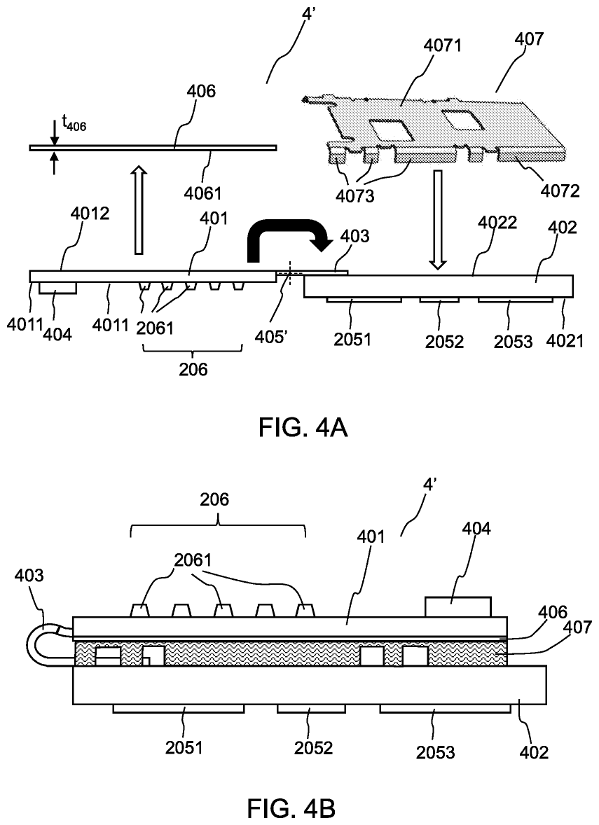

FIG. 4A shows a schematic side elevation illustration of a second embodiment of a control board assembly according to the present disclosure, the control board assembly being in an unfolded state.

FIG. 4B shows a schematic side elevation illustration of the control board assembly of FIG. 4A after transition from the unfolded state to a folded state.

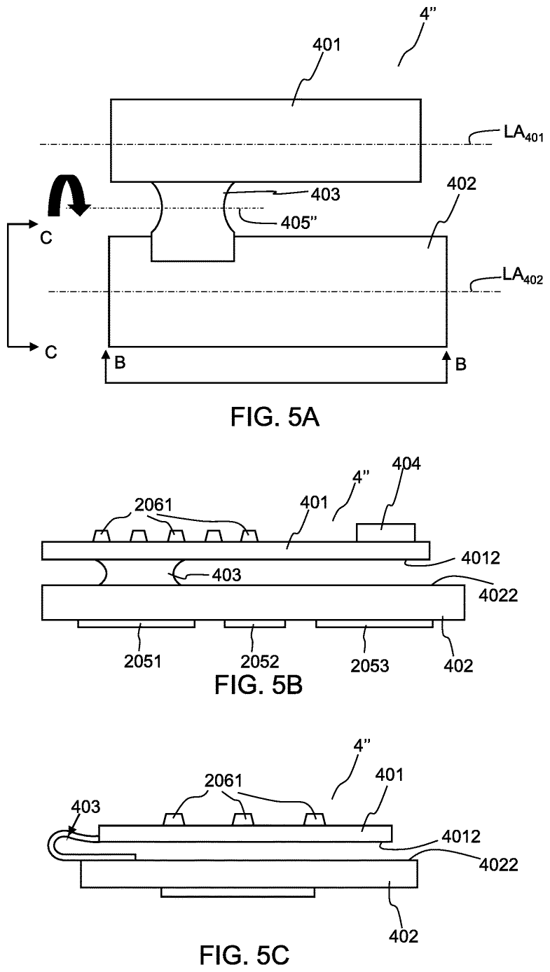

FIG. 5A shows a schematic plan illustration of a third embodiment of a control board assembly according to the present disclosure, the control board assembly being in an unfolded state.

FIG. 5B shows a schematic side elevation illustration of the control board assembly of FIG. 5A, in the direction of B-B of FIG. 5A, after transition from the unfolded state to a folded state.

FIG. 5C shows a schematic side elevation illustration of the control board assembly of FIG. 5A, in the direction of C-C of FIG. 5A, after transition from the unfolded state to the folded state.

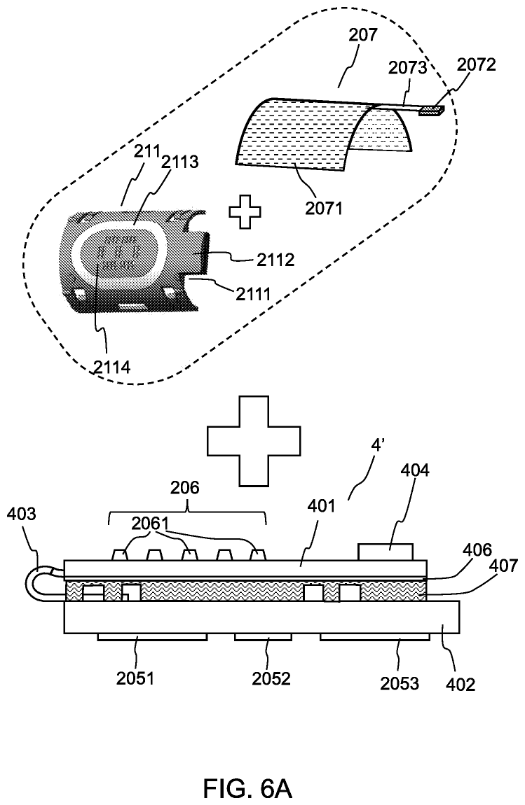

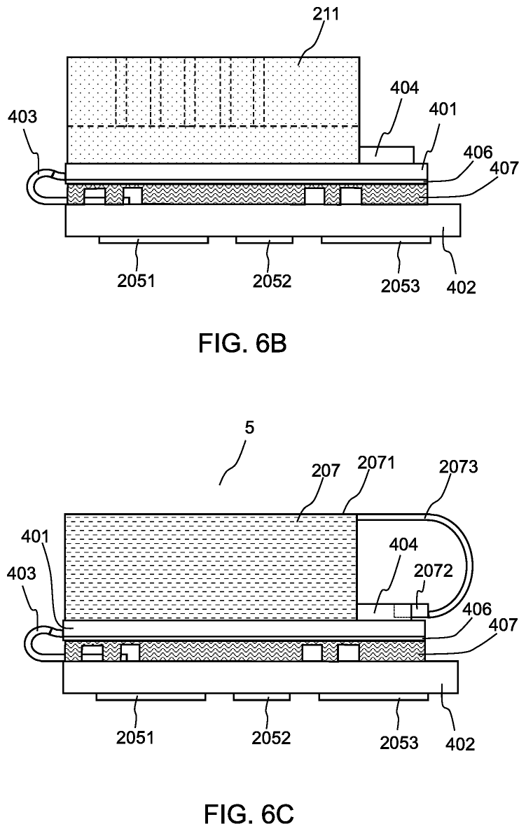

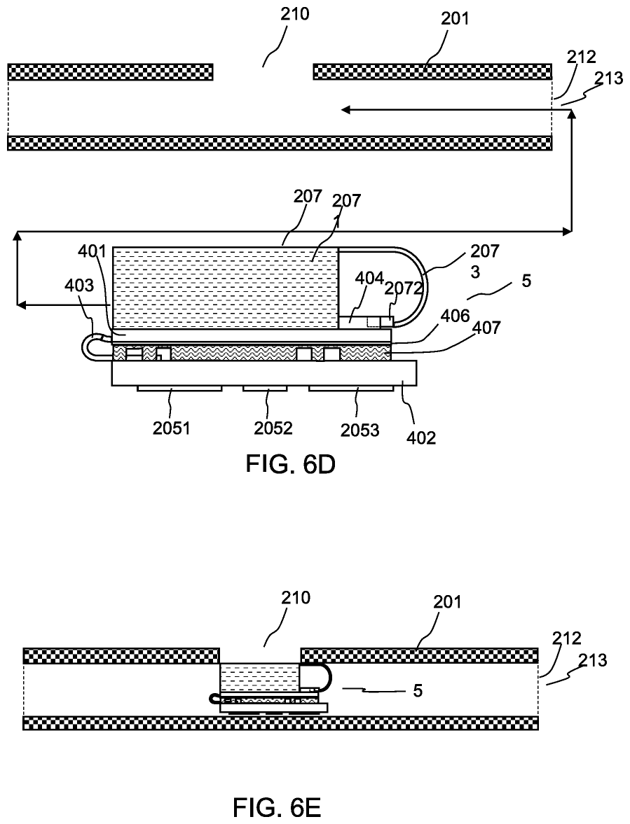

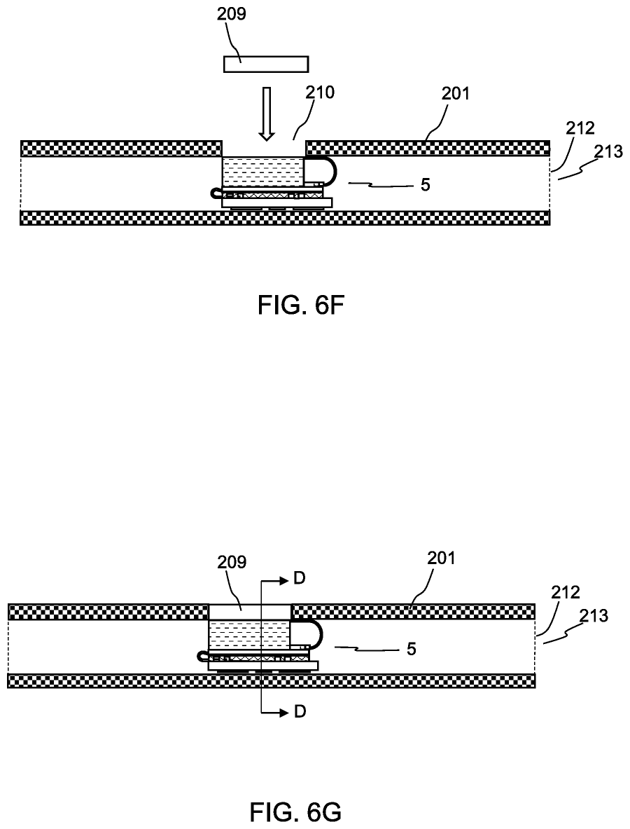

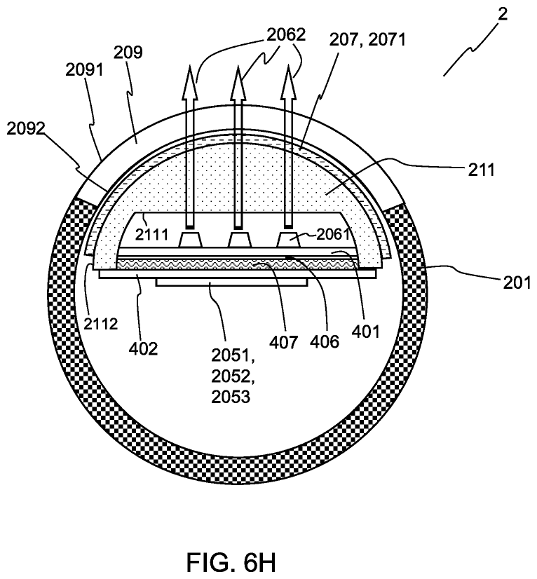

FIG. 6A shows a schematic side elevation illustration of the folded control board assembly of FIG. 4B, along with a separate light guide assembly and a separate touch sensing module.

FIG. 6B shows a schematic side elevation illustration of the control board assembly in a state subsequent to that shown in FIG. 6A, after the light guide assembly has been mounted to the control board assembly.

FIG. 6C shows a schematic side elevation illustration of the control board assembly in a state subsequent to that shown in FIG. 6B, after the touch sensing module has been positioned over the light guide assembly to form an intermediate assembly module.

FIG. 6D shows a schematic illustration of an elongate cylindrical housing of an aerosol-generating device, with the figure illustrating how the intermediate assembly module of FIG. 6C is to be inserted into an opening located at an end of the housing.

FIG. 6E shows a schematic illustration of the housing of the aerosol-generating device after the intermediate assembly module has been slid to a predetermined location within the housing.

FIG. 6F shows a schematic illustration of a display window being installed in an aperture defined in the housing.

FIG. 6G shows a schematic illustration of the aerosol-generating device after installation of the display window in the aperture.

FIG. 6H shows a schematic cross-sectional illustration through section D-D of the aerosol-generating device of FIG. 6G.

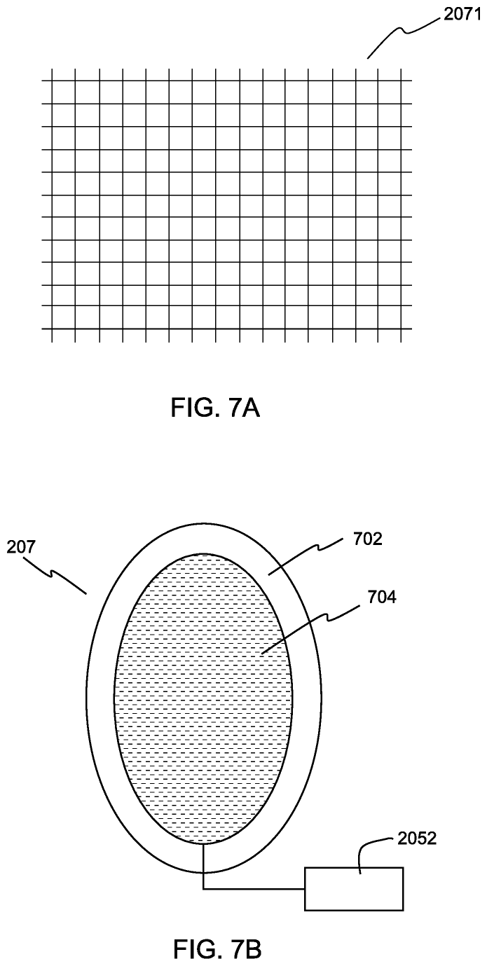

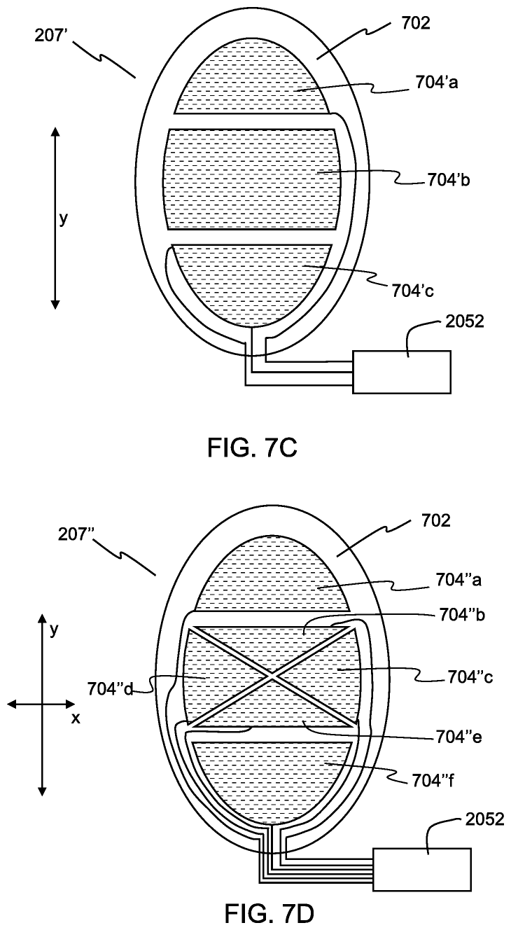

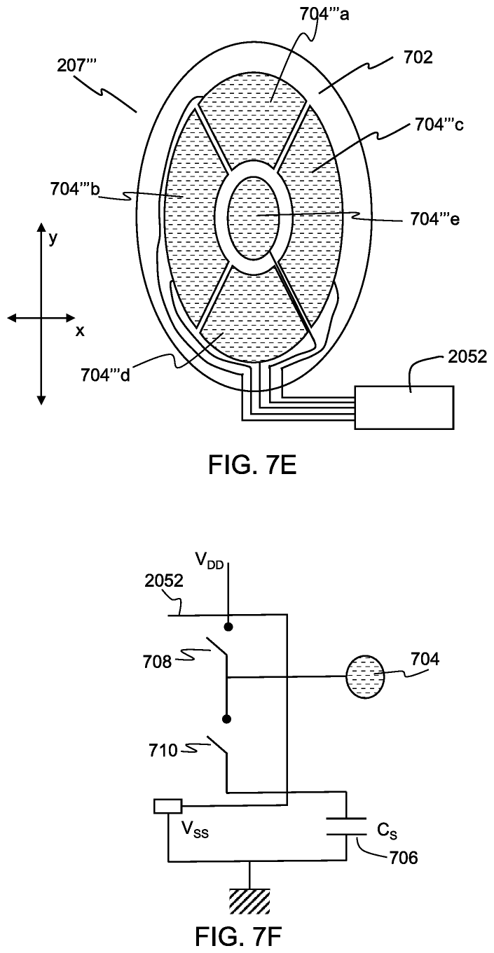

FIG. 7A shows a schematic plan illustration of a mesh for use in forming a capacitive touch foil mesh of the touch sensing module (also referred to herein as a touch sensor) illustrated in FIG. 6A.

FIGS. 7B to 7E illustrate examples of touch sensing modules, also referred to herein as touch sensors.

FIG. 7F illustrates a circuit for detecting touch events.

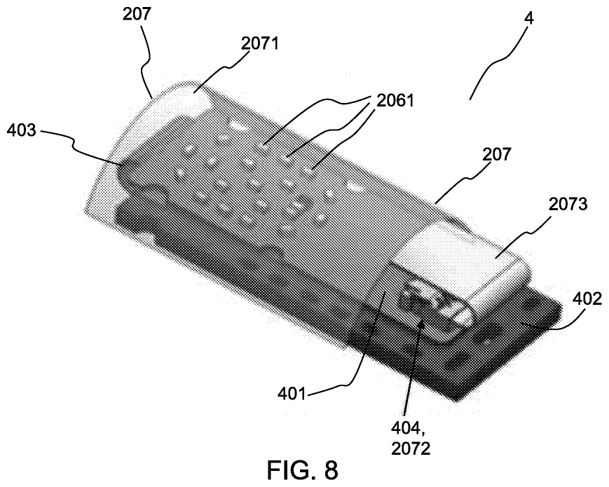

FIG. 8 shows a schematic perspective illustration from above of the control board assembly of FIG. 3D, with a touch sensing module arranged over and coupled to the control board assembly.

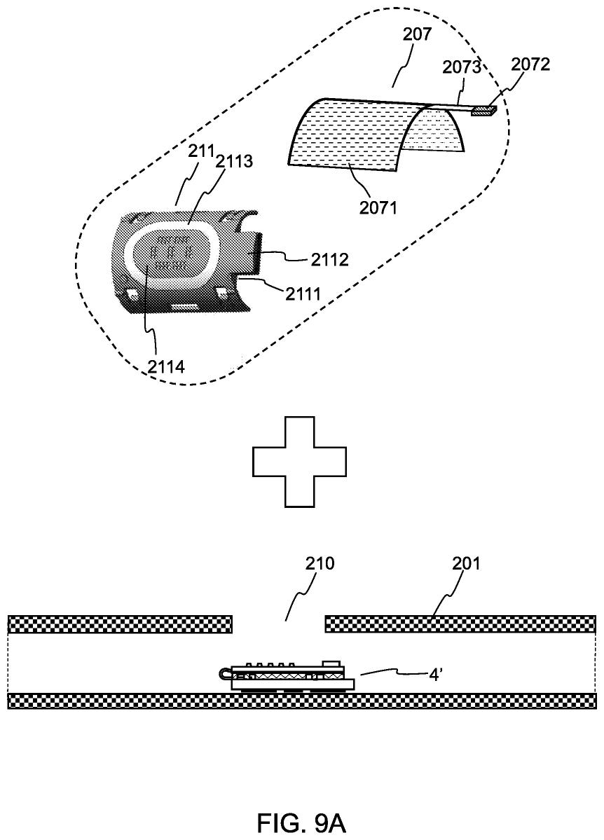

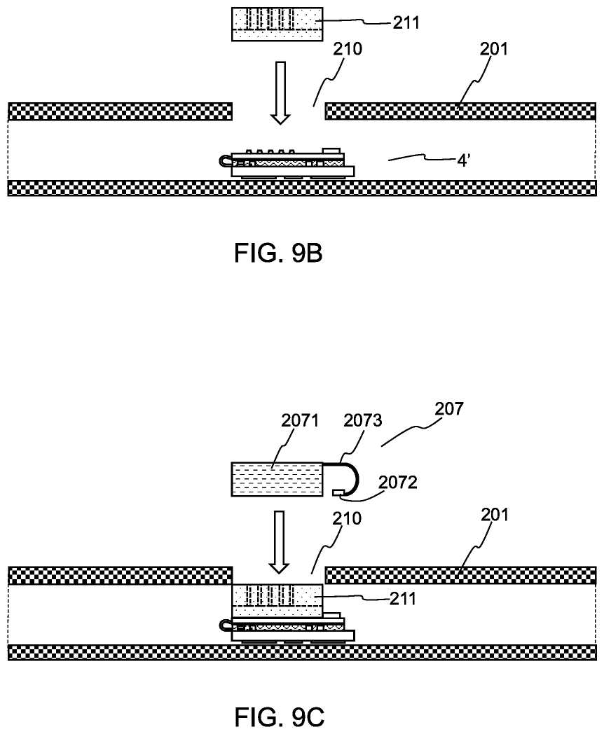

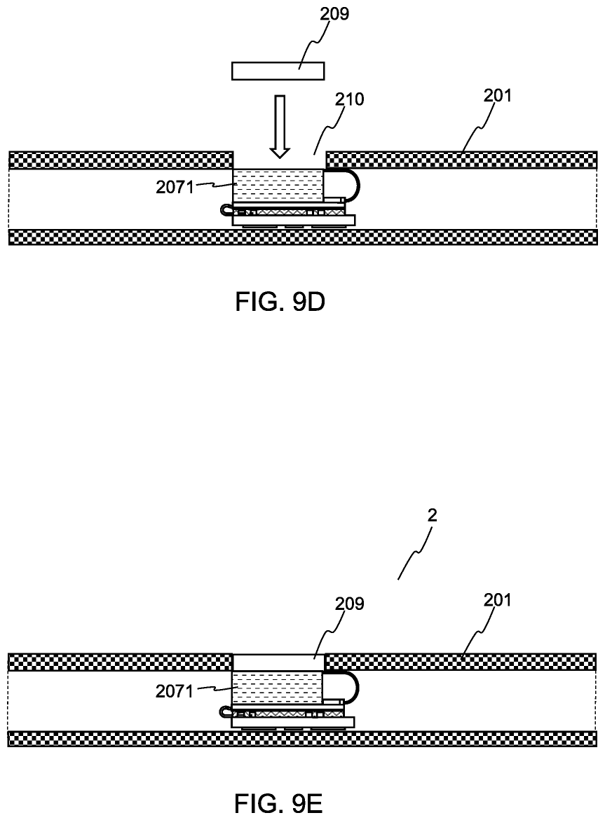

FIG. 9A shows a schematic illustration of an elongate cylindrical housing of an aerosol-generating device, with the control board assembly of FIG. 4B preinstalled inside the housing adjacent to an aperture formed in the housing, with a separate light guide assembly and separate touch sensing module outside of the housing.

FIG. 9B shows a schematic illustration of the light guide assembly being inserted through the aperture to overlie the control board assembly.

FIG. 9C shows a schematic illustration of the touch sensing module being inserted through the aperture to overlie an outward-facing surface of the light guide assembly.

FIG. 9D shows a schematic illustration of a display window being installed in the aperture.

FIG. 9E shows a schematic illustration of the aerosol-generating device after installation of the display window in the aperture.

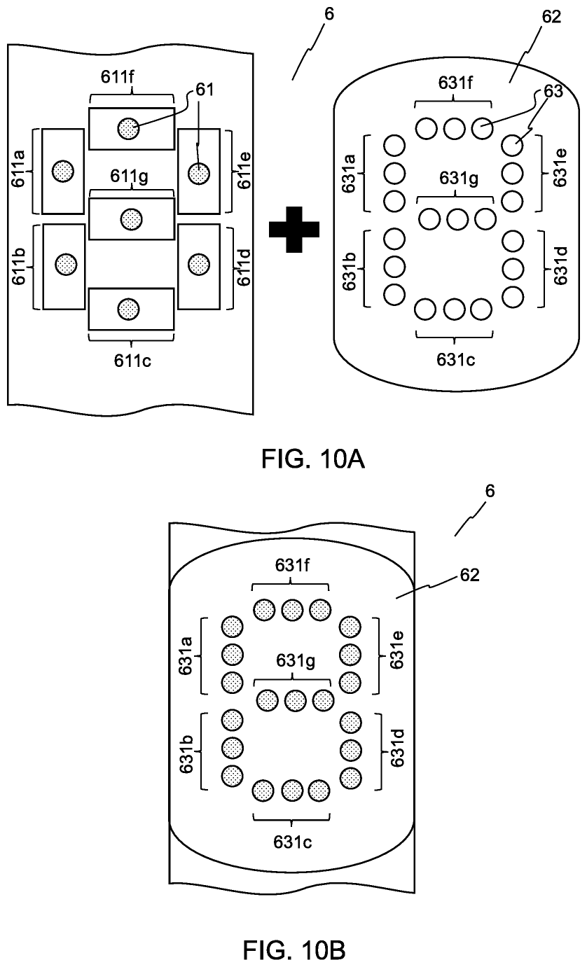

FIGS. 10A and 10B show a schematic plan illustration of a first embodiment of a lighting system prior to and after assembly respectively.

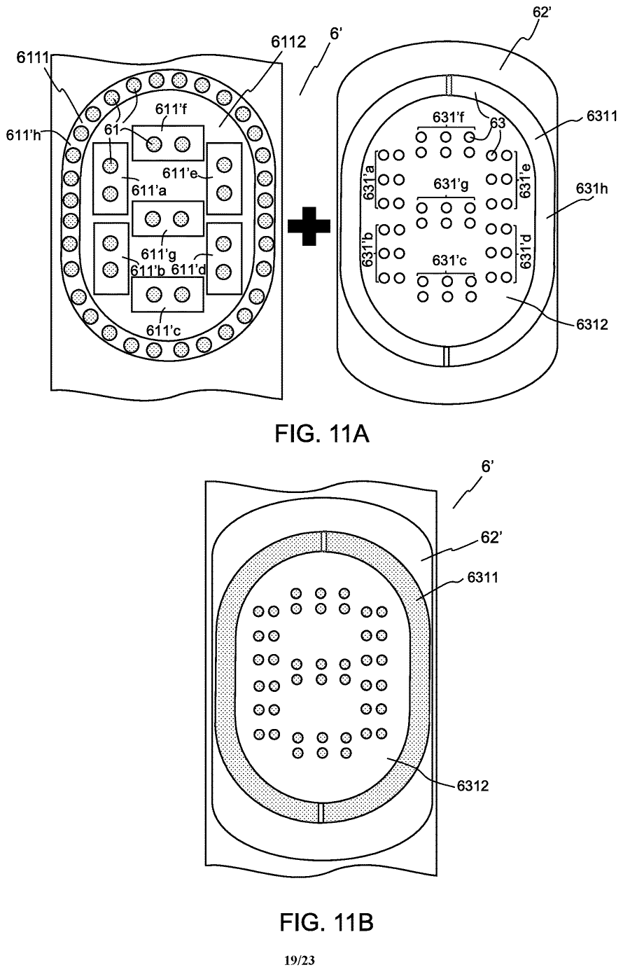

FIGS. 11A and 11B show a schematic plan illustration of a second embodiment of a lighting system prior to and after assembly respectively.

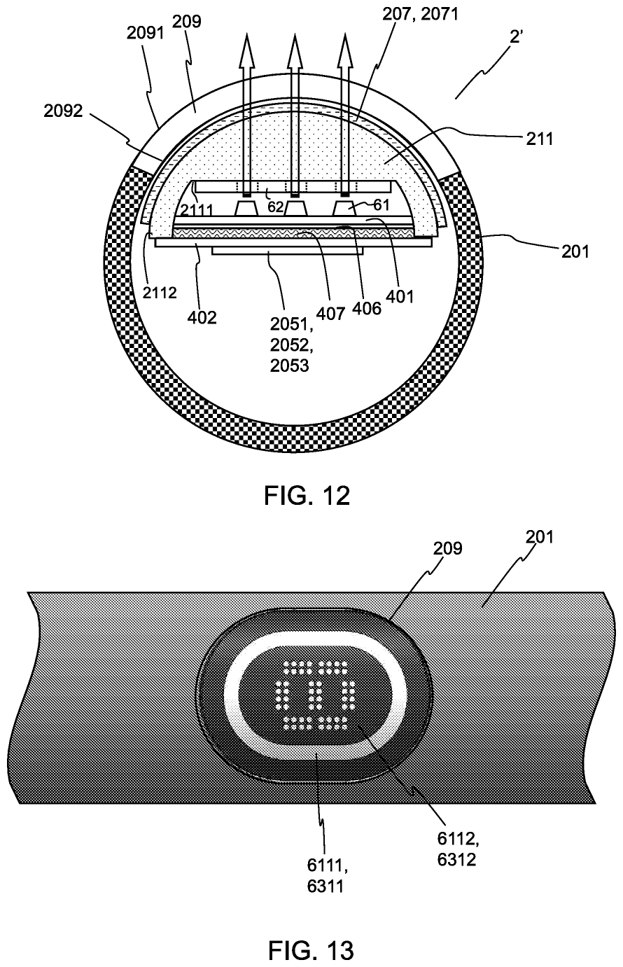

FIG. 12 shows a schematic cross-sectional illustration of an embodiment of an aerosol-generating device incorporating the lighting system of FIG. 10.

FIG. 13 shows a plan view of a display window of an aerosol-generating device, in which the display window overlies the lighting system of FIG. 11.

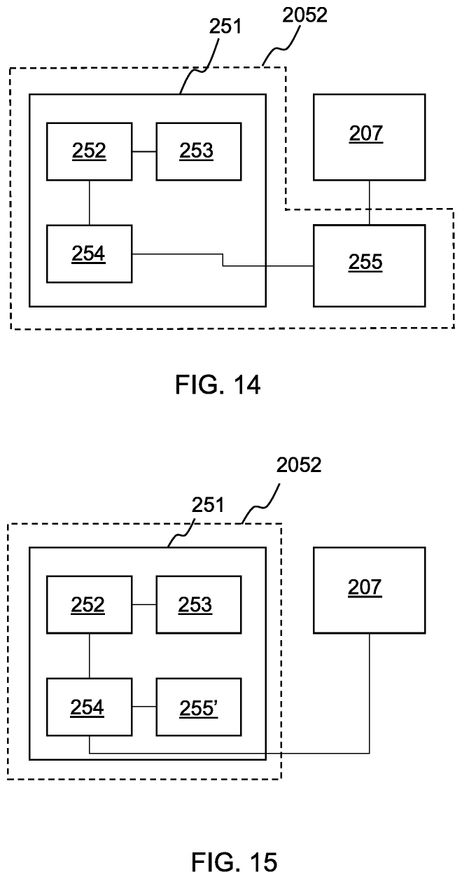

FIG. 14 shows a schematic representation of an embodiment of touch-sensing control electronics for controlling operation of a capacitive touch sensor of the aerosol-generating device illustrated in the above figures.

FIG. 15 shows a schematic representation of an alternative embodiment of touch-sensing control electronics for controlling operation of a capacitive touch sensor of the aerosol-generating device illustrated in the above figures.

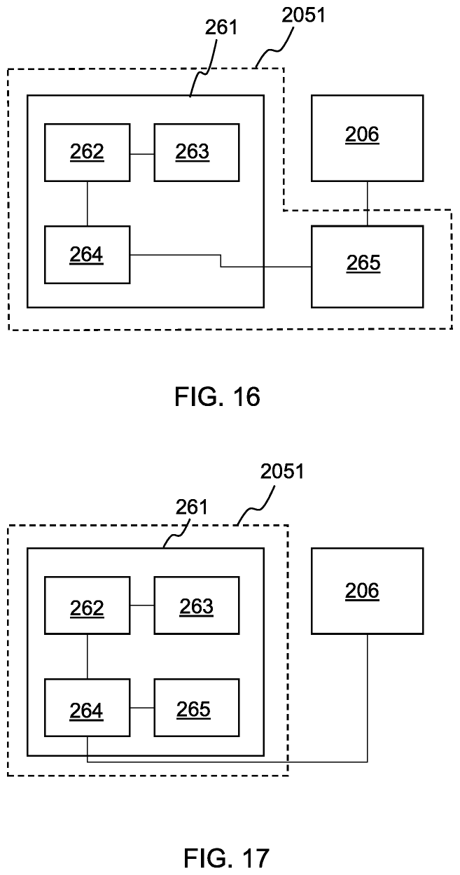

FIG. 16 shows a schematic representation of an embodiment of lighting control electronics for controlling operation of a lighting assembly of the aerosol-generating device illustrated in the above figures.

FIG. 17 shows a schematic representation of an alternative embodiment of lighting control electronics for controlling operation of a lighting assembly of the aerosol-generating device illustrated in the above figures.

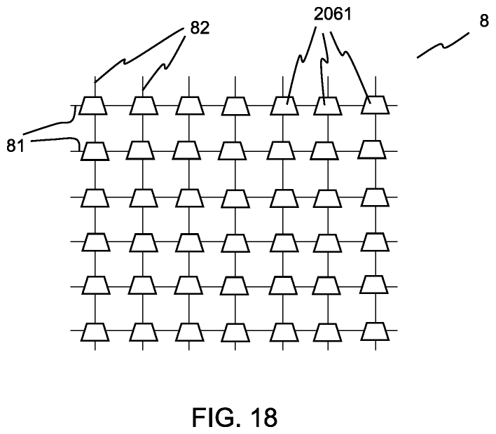

FIG. 18 shows a schematic representation of an arrangement of intersecting row & column pins and accompanying LEDs, for use as part of a lighting assembly of the aerosol-generating device illustrated in the above figures.

FIG. 1 shows the components of an aerosol-generating system 1. The aerosol-generating system 1 has an aerosol-generating device 2 and an aerosol-generating article 3. As will be described below, the aerosol-generating device 2 is adapted to receive the aerosol-generating article 3.

The aerosol-generating article 3 has a wrapper 301 enclosing a rod of aerosol-forming substrate 302 and a mouthpiece element 303. The wrapper 301 may be a cigarette paper or similar. The rod of aerosol-forming substrate 302 is positioned at a distal end 304 of the article 3 and the mouthpiece element 303 positioned at a mouth end 305 of the article. The mouthpiece element 303 may be a filter element formed of cellulose acetate or other suitable material. A susceptor element 306 of ferromagnetic material is positioned inside the rod of aerosol-forming substrate 302.

The aerosol-generating device 2 has an elongate tubular housing 201 extending along a longitudinal axis LA₂. The elongate housing 201 may be formed of a polymer material or other material possessing suitable stiffness. The housing 201 is sized so as to be suitable for being handheld by a user. A blind cavity 202 is defined at a first end 203 of the housing 201. In the embodiment shown in FIG. 1, the housing 201 is cylindrical in cross-section. The cavity 202 is sized to receive the distal end 304 of the aerosol-generating article 3 such that the cavity receives all of the length of the rod of aerosol-forming substrate 302. A power source 204, control electronics 205, lighting assembly 206 and touch sensor 207 are contained inside the interior of the housing 201. In the illustrated embodiment, the power source 204 is a rechargeable battery; for example, the battery may be a lithium-ion battery. An electric heating arrangement is also provided inside the housing. More specifically, in the illustrated embodiment of FIG. 1 the electric heating arrangement is in the form of an inductor coil 208 surrounding the cavity 202. In other embodiments (not shown), the electric heating arrangement may be a resistive heating element; for example, the resistive heating element may have a blade extending from a base of the cavity 202 towards the first end 203 of the housing 201.

The control electronics 205 includes a lighting control electronics section 2051, a touch-sensing control electronics section 2052 and a heating control electronics section 2053. Although not shown in FIG. 1, the control electronics 205 may also include sections relating to the control of other functions of the aerosol-generating device 2. Each of the lighting, touch-sensing and heating control electronics sections 2051, 2052, 2053 may include a controller and a memory module, the memory module containing instructions accessible by the respective controller to enable the respective control electronics section to perform one or more control functions. In the case of the embodiment of the aerosol-generating device 2 shown in FIG. 1, the heating control electronics section 2053 also includes a DC/AC converter (not shown) to convert DC current provided by the battery 204 to an alternating current. As shown schematically in FIG. 1, the lighting control electronics section 2051 is coupled to the lighting assembly 206, the touch-sensing control electronics section 2052 is coupled to the touch sensor 207, and the heating control electronics section 2053 is coupled to the inductor coil 208. Although not shown in FIG. 1, each of the control electronics sections (lighting, touch-sensing and heating) are also communicably coupled to each other so that an input/output to or from one of the control electronics sections may result in a corresponding control input to and/or control output from another of the control electronics sections.

A display window 209 is defined in the housing 201 of the device 2. The outline of the display window 209 is shown in broken outline in FIG. 1. The display window 209 is a transparent plastic insert installed in an aperture 210 defined in the housing 201 of the device 2 (see FIGS. 1 and 2). However, the display window 209 may be formed from other light transmissive materials, such as glass. As will be described in more detail below, the display window 209 serves as both a touch interface for a user to provide control inputs to the device 2 and a window through which one or more light emissions from the lighting assembly 206 may be viewed. The light emissions may be informative of various states of the aerosol-generating device 2. FIG. 2 illustrates an outward-facing surface 2091 of the display window 209 serving as a touch interface for a user.

Prior to activation of the aerosol-generating device 2, the aerosol-generating article 3 is inserted into the cavity 202 of the device. When the article 3 has been fully inserted into the cavity 202, the length of the rod of aerosol-forming substrate 302 is surrounded by the inductor coil 208. On activation of the device 2, the heating control electronics section 2053 controls the supply of alternating electric current from the battery 204 to the inductor coil 208 in accordance with instructions contained in a memory module (not shown) of the heating control electronics section. Activation of the aerosol-generating device 2 may occur automatically on insertion of the aerosol-generating article 3 into the cavity 202 of the device (for example, a sensor may be arranged within the cavity, the sensor configured to detect insertion of the aerosol-generating article). Alternatively, the aerosol-generating device 2 may be activated by a user engaging their finger with the touch interface defined by the outward-facing surface 2091 of the display window 209, with the touch-sensing control electronics section 2052 sensing the touch event and communicating with the heating control electronics section 2053 to commence supply of current from the battery 204 to the inductor coil 208 in order to heat the aerosol-forming substrate 302 of the aerosol-generating article 3. The touch-sensing control electronics section 2052 may also communicate with the lighting control electronics section 2051 to result in the lighting assembly 206 generating a light emission informing the user of the activation of the device 2 and/or a current operational state of the device.

For the aerosol-generating device 2 illustrated in FIG. 1, alternating current through the inductor coil 208 generates a magnetic field. The susceptor element 306 lies within this magnetic field. The magnetic field induces heating of the susceptor element 306 through one or both of eddy currents and magnetic hysteresis. The heating control electronics section 2053 controls the supply of current to the inductor coil 208 in accordance with a heating profile stored in a memory module of the heating control electronics section. The lighting assembly 206 may generate one or more light emissions in response to one or more control inputs by the user, and/or in response to and informative of a given state of the aerosol-generating device 2.

FIGS. 3A to 3D show a first embodiment of a control board assembly 4 for use in the aerosol-generating device 2. The control board assembly 4 contains the control electronics 205 schematically illustrated in FIG. 1. The control board assembly 4 has a first elongate control board 401, a second elongate control board 402, with a hinge element 403 coupling the first and second controls boards to each other. The first control board 401 has a length L₄₀₁ of 20 millimetres, a width W₄₀₁ of 7 millimetres and a thickness t₄₀₁ of 0.7 millimetres. The second control board 402 has a length L₄₀₂ of 25 millimetres, a width W₄₀₂ of 10 millimetres and a thickness t₄₀₂ of 1 millimetre. In the unfolded state of FIG. 3A, the hinge element 403 separates the longitudinal ends of the first and second control boards by a distance L₄₀₃ of 5 millimetres. In other embodiments, the first and second control boards 401, 402 may have a length dimension (L₄₀₁, L₄₀₂) in a range of 10 millimetres to 60 millimetres, or 15 millimetres to 45 millimetres, or 15 millimetres to 30 millimetres. In other embodiments, the first and second control boards 401, 402 may have a width dimension (W₄₀₁, W₄₀₂) in a range of 5 millimetres to 35 millimetres, or 5 millimetres to 25 millimetres, or 5 millimetres to 15 millimetres. In other embodiments, the first and second control boards 401, 402 may have a thickness dimension (t₄₀₁, t₄₀₂) in a range of 0.2 millimetres to 5 millimetres, or 0.2 millimetres to 3 millimetres, or 0.5 millimetres to 2 millimetres. The first control board 401 is formed from a first material composition. The second control board 402 is formed from a second material composition. The first material composition may be a polymer material, whereas the second material composition may be a ceramic material; however, it will be appreciated that other materials may be employed for the first and second material compositions. The first material composition has a lower stiffness than that of the second material composition. For the illustrated embodiment of FIGS. 3A to 3D, the hinge element 403 is an elongate integral extension of the first control board 401 (being formed from the first material composition), extending from one of the longitudinal ends of the first control board and coupled to the second control board 402. The coupling of the hinge element 403 to the second control board 402 may be achieved by use of adhesive between corresponding surfaces of the hinge element and the second control board to define an adhesive interface therebetween. Dependent on the choice of adhesive used, the adhesive interface may be peelable to allow uncoupling of the first and second control boards 401, 402 from each other. The coupling of the hinge element 403 to the second control board 402 may also be achieved by use of a push-fit connection interface. For the illustrated embodiment, the lighting control electronics section 2051, the touch-sensing control electronics section 2052 and the heating control electronics section 2053 are each mounted to a surface 4021 of the second control board 402. A lighting assembly 206 formed of a plurality of LEDs 2061 is arranged on a surface 4011 of the first control board 401. The lighting assembly 206 is coupled to the lighting control electronics 2051 section by means of one or more electrically conductive tracks (not shown) extending between the first and second control boards 401, 402, the tracks embedded in or overlaid on a surface of the hinge element 403. A zero interface force (“ZIF”) connector 404 or similar is also provided on surface 4011 of the first control board 401. The ZIF connector 404 is provided to allow for electromechanical connection between the control board assembly 4 and a touch sensor 207 (such as the touch sensor 207 schematically shown in FIG. 1). The ZIF connector 404 is coupled to the touch-sensing control electronics section 2052 by means of one or more electrically conductive tracks (not shown) extending between the first and second control boards 401, 402, the tracks embedded in or overlaid on a surface of the hinge element 403.

The control board assembly 4 has an initial unfolded state—as shown in FIGS. 3A and 3B—in which the first and second control boards 401, 402 are arranged in end to end relationship with each other, with the hinge element 403 coupling opposed longitudinal ends of the two control boards to each other. To facilitate insertion of the control board assembly 4 inside the interior of the housing 201 of the aerosol-generating device 2, the first control board 401 is folded about a fold axis 405 aligned generally perpendicular to the common longitudinal axis LA₄ of the first and second control boards so as to overlie the second control board 402. The direction of folding about the fold axis 405 is represented by arrows in FIGS. 3A and 3B. FIGS. 3C and 3D show the control board assembly 4 in the folded state. In the folded state, opposed inward-facing surfaces 4012, 4022 of the first and second control boards 401, 402 are spatially separated from each other.

FIGS. 4A and 4B show a second embodiment of a control board assembly 4′ for use in the aerosol-generating device 2, in unfolded and folded states respectively. This second embodiment includes all of the elements of the first embodiment of FIGS. 3A to 3D. However, in this second embodiment a stiffening member 406 and a separator element 407 are also provided. The stiffening member 406 is in the form of a plate formed of a material having a stiffness greater than the first material composition of the first control board 401.

The stiffening member 406 may be formed from metal, plastic or any suitable material having a greater stiffness than the first material composition. The stiffening member 406 has a thickness t₄₀₆ of 0.2 millimetres. In other embodiments, the stiffening member 406 may be different in thickness. Further, the thickness chosen for the stiffening member 406 may be influenced by the choice of material used for the stiffening member and the stiffness of that material. In the unfolded state, the flexible first control board 401 is overlaid on to a support surface 4061 of the stiffening member 406. The stiffening member 406 and its support surface 4061 are generally planar. The separator element 407 is formed from a material having a stiffness greater than the first material composition of the first control board 401. In the embodiment illustrated in FIGS. 4A and 4B, the separator element 407 is formed of sheet metal; however, in other embodiments, alternative materials may be used for the separator element 407. A major portion 4071 of the separator element 407 is generally planar, with a pair of laterally opposed longitudinally extending edges 4072 of the separator element bent perpendicular to the major portion. In the unfolded state, the separator element 407 is positioned so that feet 4073 defined on each of the two laterally opposed longitudinally extending edges 4072 locate against surface portions of the second control board 402. To reduce the likelihood of the sheet metal of the separator element 407 resulting in a short circuit between electrical components of the first and second control boards 401, 402, the surface portions of the second control board against which the feet 4073 of the separator element 407 locate are electrically isolated from electrical circuitry of the second control board. With the stiffening member 406 and separator element 407 located against surfaces 4012, 4022 of the first control board 401 and the second control board 402 respectively, the first control board is folded about a fold axis 405′ aligned generally perpendicular to the common longitudinal axis of the first and second control boards so as to overlie the second control board. The direction of folding is represented by an arrow in FIG. 4A, with the fold axis 405′ extending into the page. FIG. 4B shows the control board assembly 4′ in the folded state. The separator element 407 helps to maintain separation between the opposed inward-facing surfaces 4012, 4022 of the first and second control boards 401, 402 in the folded state.

FIGS. 5A to 5C show a third embodiment of a control board assembly 4″ for use in the aerosol-generating device 2. This second embodiment includes all of the elements of the first embodiment of FIGS. 3A to 3D. However, in the initial unfolded state, the first control board 401 and the second control board 402 are laterally spaced apart from each other rather than being in end to end relationship. As shown in FIG. 5A, the longitudinal axes LA₄₀₁, LA₄₀₂ of the first and second control boards 401, 402 are parallel and spaced apart from each other, with the hinge element 403 extending laterally between opposed longitudinally extending edges of the first and second control boards. To facilitate insertion of the control board assembly 4″ inside the interior of the housing 201 of the aerosol-generating device 2, the first control board 401 is folded about a fold axis 405″ aligned generally parallel to the longitudinal axes LA₄₀₁, LA₄₀₂ of the first and second control boards to as to overlie the second control board 402. The direction of folding about the fold axis 405″ is represented by an arrow in FIG. 5A. FIGS. 5B and 5C each show the control board assembly 4″ in the folded state, with FIG. 5B showing a side elevation view in the direction of B-B of FIG. 5A and FIG. 5C showing a side elevation view in the direction of C-C of FIG. 5A. Again, in the folded state, the opposed inward-facing surfaces 4012, 4022 of the first and second control boards 401, 402 are spatially separated from each other. It will be appreciated that one or both of the stiffening member 406 and the separator element 407 of the embodiment of FIGS. 4A and 4B may also be used in the embodiment of FIGS. 5A to 5C.

FIGS. 6A to 6H are provided to help illustrate a first exemplary method of assembly of the aerosol-generating device 2.

FIG. 6A shows the control board assembly 4′ of FIG. 4B. The control board assembly 4′ can be said to form a control module. Also shown in FIG. 6A is a light guide assembly 211 and touch sensor 207. In the state shown in FIG. 6A, the light guide assembly 211 and touch sensor 207 are uncoupled from each other and from the control board assembly 4. The light guide assembly 211 is configured for directing light between opposed inward and outward-facing surfaces 2111, 2112 of the light guide assembly and may have a plurality of channels extending between the inward and outward-facing surfaces. The outward-facing surface 2112 of the light guide assembly 211 is generally convex in profile. In use, light is directed between the inward and outward-facing surfaces 2111, 2112 of the light guide assembly 211 to emerge at two distinct regions on the outward-facing surface. These two distinct regions are an annular outer region 2113 and a central inner region 2114. The outer region 2113 surrounds the inner region 2114. For the light guide assembly 211 shown in FIG. 6A, the outer region 2113 is generally continuous whereas the inner region 2114 consists of a plurality of discrete apertures.

In one example, the touch sensor 207 has an electrically conductive foil mesh 2071 and a ZIF connector 2072. The ZIF connector 2072 is coupled to the foil mesh 2071 by a cable 2073. The foil mesh 2071 is formed of a mesh of copper wires spaced apart from each other, as shown in FIG. 7A, with each wire of the mesh defining an electrode of the foil mesh. However, it will be appreciated that the foil mesh 2071 may be formed from electrically conductive materials other than copper, and that other types of touch sensor could be used (such as those described herein). In another example, the touch sensor 207 comprises one or more electrically conductive regions. The one or more electrically conductive regions may be arranged on an electrically insulating layer, or film. Each one of the electrically conductive regions may have a single or a plurality of electrical connections with an integrated circuit (such as a microcontroller) of the touch-sensing control electronics section 2052 for sensing one or more touch inputs.

FIGS. 7B-E illustrate examples of touch sensors 207, each comprising one or more electrically conductive regions 704 arranged on an electrically insulating layer 702. Each electrically conductive region 704 is connected to the touch-sensing control electronics section 2052 for sensing one or more touch inputs. FIG. 7F illustrates the principle of operation that enables the touch-sensing control electronics section 2052 to detect touch events.

In the touch sensor 207 shown in FIG. 7B, there is a single electrically conductive region 704 arranged on an insulating layer 702. The electrically conductive region 704 is connected to the touch-sensing control electronics section 2052, which is described with reference to FIG. 7F. The electrically conductive region 704 is shielded from direct electrical contact with objects outside of the aerosol-generating device 2 via the display window 209.

Referring to FIG. 7F, the touch-sensing control electronics section 2052 comprises a first switch 708 and a second switch 710. The electrically conductive region 704 is electrically connected between the first switch 708 and the second switch 710. The electrically conductive region 704 may have a capacitance. The capacitance of the electrically conductive region 704 may be up to 100 pF, between 5 pF and 50 pF, between 10 pF and 30 pF, or between 15 pF and 25 pF.

The touch-sensing control electronics section 2052 controls the first and second switches 708, 710 by opening the second switch 710 and closing the first switch 708 for a first time duration (T1). During T1, an electrical charge forms due to the capacitance of the electrically conductive region 704.

Then, the touch-sensing control electronics section 2052 opens the first switch 708 and closes the second switch 710 for a second time duration (T2). During T2, the charge accumulated at the electrically conductive region 704 is transferred to a sensing capacitor 706.

The touch-sensing control electronics section 2052 determines the time taken (Tx) for the sensing capacitor 706 to reach a voltage threshold (Vth). The determined value for Tx is indicative of a touch event. For example, Tx will be equal to a value within a certain range or above a threshold when there is no touch event; for example, when a user is not touching the display window 209. However, if there is a touch event (for example, when a user presses the display window 209 with a finger), there will be a larger capacitance at the electrically conductive region 704 and Vth will be reached more quickly. In other words, when there is a touch event, Tx will be shorter. Thus, the touch-sensing control electronics section 2052 determines that a touch event has occurred by determining that Tx is within a range associated with a touch event, or that Tx has breached a threshold associated with a touch event.

In the touch sensor 207′ shown in FIG. 7C, there are three electrically conductive regions 704′a, 704′b, 704′c on an electrically insulating layer 702. Each one of the electrically conductive regions 704′a, 704′b, 704′c is connected to the touch-sensing control electronics section 2052 which detects touch events as described with reference to FIG. 7F.

Since there is a plurality of electrically conductive regions, the touch-sensing control electronics section 2052 can determine a region of the display window 209 that has been touched. If a touch event is detected at electrically conductive region 704′a, the touch-sensing control electronics section 2052 determines that the top of the window 209 has been touched. If a touch event is detected at electrically conductive region 704′b, the touch-sensing control electronics section 2052 determines that the middle of the window 209 has been touched. If a touch event is detected at electrically conductive region 704′c, the touch-sensing control electronics section 2052 determines that the bottom of the window 209 has been touched.

Since the touch sensor 207′ has electrically conductive regions 704′a, b, c distributed along an axis y, the touch-sensing control electronics section 2052 can determine a direction of movement of a user's finger along the axis y. For instance, if a touch event is detected at electrically conductive region 704′a, then 704′b, and then 704′c, the touch-sensing control electronics section 2052 determines that the user has swiped down along the y axis. Alternatively, if a touch event is detected at electrically conductive region 704′c, then 704′b, and then 704′a, the touch-sensing control electronics section 2052 determines that the user has swiped up along the y axis. The touch-sensing control electronics may be configured to perform a function associated with a touch event at a particular electrically conductive region and/or to perform a function associated with a particular direction of movement (or gesture) performed by a user's finger.

In the touch sensor 207″ shown in FIG. 7D, there are six electrically conductive regions 704″a, 704″b, 704″c, 704″d, 704″e, 704″f on an electrically insulating layer 702.

Each one of the electrically conductive regions 704″a, 704″b, 704″c, 704″d, 704″e, 704″f is connected to the touch-sensing control electronics section 2052 which detects touch events as described with reference to FIG. 7F.

The touch-sensing control electronics section 2052 can determine a region of the display window 209 that has been touched by detecting a touch event at regions 704″a-f corresponding with a region at the window 209. The touch-sensing control electronics section 2052 detects the location of a touch event in a similar manner to as described with reference to FIG. 7C.

Since the touch sensor 207″ has electrically conductive regions 704″a-f distributed across a two-dimensional area, the touch-sensing control electronics can determine a direction of movement of a user's finger along an axis y and a second axis x. For instance, if a touch event is detected at electrically conductive region 704″d, and then 704″c, the touch-sensing control electronics section 2052 determines that the user has swiped right along the x axis. Alternatively, if a touch event is detected at electrically conductive region 704″c, then 704″d, the touch-sensing control electronics section 2052 determines that the user has swiped left along the x axis. Movement along the y axis can be detected in a similar manner to as described with reference to FIG. 7C.

It is also possible to detect movement in a diagonal direction. For instance, the touch-sensing control electronics 2052 can determine a movement of a finger upwards and rightwards by detecting a touch event at region 704″e and then at region 704″c.

The touch-sensing control electronics may be configured to perform a function associated with a touch event at a particular electrically conductive region and/or to perform a function associated with a particular direction of movement (or gesture) performed by a user's finger.

In the touch sensor 207″′ shown in FIG. 7E, there are five electrically conductive regions 704″′a, 704″′b, 704″′c, 704″′d, 704″′e on an electrically insulating layer 702. Specifically, there is a central region 704″′e surrounded by a plurality of separate regions 704″′a, 704″′b, 704″′c, 704″′d. Each one of the electrically conductive regions 704″′a, 704″′b, 704″′c, 704″′d, 704″′e is connected to the touch-sensing control electronics section 2052 which detects touch events as described with reference to FIG. 7F.

The touch-sensing control electronics section 2052 can determine a region of the display window 209 that has been touched by detecting a touch event at region 704″′a-e corresponding with a region at the window 209. The touch-sensing control electronics section 2052 detects the location of a touch event in a similar manner to as described above.

Since the touch sensor 207″′ has electrically conductive regions 704″′a-e distributed across a two-dimensional area, the touch-sensing control electronics can determine a direction of movement of a user's finger along an axis y and a second axis x as described above.

The touch-sensing control electronics may be configured to perform a function associated with a touch event at a particular electrically conductive region and/or to perform a function associated with a particular direction of movement (or gesture) performed by a user's finger.

As shown in FIG. 6B, subsequent to the state shown in FIG. 6A, the light guide assembly 211 is mounted to the first control board 401 of the control board assembly 4′ so as to overlie the lighting assembly 206.

As shown in FIG. 6C, subsequent to the state shown in FIG. 6B, the foil mesh 2071 of the touch sensor 207 is arranged over and in contact with the convex outward-facing surface 2112 of the light guide assembly 211. The foil mesh 2071 of the touch sensor 207 may be preformed into the convex profile illustrated in FIG. 6A and then simply placed onto the convex outward-facing surface 2112 of the light guide assembly 211. Alternatively, the foil mesh 2071 of the touch sensor 207 may be initially provided in a planar state and subsequently deformed into the convex profile shown in FIG. 6A during the process of overlaying the foil mesh onto the convex outward-facing surface 2112 of the light guide assembly 211. The convex profile of the foil mesh 2071 generally corresponds to the profile of the outward-facing surface 2112 of the light guide assembly 211 so that the foil mesh is in surface contact with the outward-facing surface of the light guide assembly. The ZIF connector 2072 of the touch sensor 207 is coupled to the corresponding ZIF connector 404 on the first control board 401, thereby establishing electrical communication between the foil mesh 2071 and the touch sensing control electronics section 2052 of the control board assembly 4′. The combination of the control board assembly 4′, light guide assembly 211 and touch sensor 207 shown in FIG. 6C forms an intermediate assembly module 5.

FIG. 6D shows a view of a portion of the length of the elongate tubular housing 201. The housing 201 includes the aperture 210 for receiving the display window 209, but for this illustrated embodiment the display window is not yet installed in the aperture. In an alternative embodiment, the display window 209 may be preinstalled in the aperture 210. An opening 212 is defined at a second end 213 of the housing 201. The intermediate assembly module 5 is initially located adjacent to the opening 212 and is then inserted into the housing 201. More specifically, the intermediate assembly module 5 is slid along the length of the housing 201 to a predetermined location. The predetermined location corresponds to the lighting assembly 206 being positioned adjacent to the aperture 210 in the housing 201-as shown in FIG. 6E.

As shown in FIG. 6F, subsequent to the state shown in FIG. 6E, the display window 209 is installed in the aperture 210 of the housing 201 to overlie the foil mesh 2071 of the touch sensor 207. FIG. 6G shows the assembled aerosol-generating device 2 after installation of the display window 209 in the aperture 210.

FIG. 6H shows a cross-section through section D-D of FIG. 6G. The display window 209 has a uniform thickness. The display window 209 also has a curvature corresponding to the curvature of the foil mesh 2071 and the outward-facing surface 2112 of the light guide assembly 211. The curvature of the display window 209 also corresponds to the curvature of the sidewall of the cylindrical elongate housing 201. The distance between a point on the outward-facing surface of the foil mesh 2071 and the outward-facing surface 2091 of the display window 209, when measured along a line normal to a point on the mesh surface, is generally uniform along the entirety of the region where the display window overlies the foil mesh. In the embodiment shown in FIG. 6H, a small air gap exists between the outward-facing surface of the foil mesh 2071 and the inward-facing surface 2092 of the display window 209. However, in other embodiments, the foil mesh 2071 may be in intimate contact with the inward-facing surface 2092 of the display window 209 such that the foil mesh is effectively sandwiched between the outward-facing surface 2112 of the light guide assembly 211 and the inward-facing surface 2092 of the display window 209.

In use, light emitted by the LEDs 2061 of the lighting assembly 206 passes through channels defined between the inward and outward-facing surfaces 2111, 2112 of the light guide assembly 211, and then through the foil mesh 2071 of the touch sensor 207, to be transmitted through the display window 209. Contact between a user's finger and a location on the outward-facing surface 2091 of the display window 209 results in a change in capacitive coupling between adjacent wires of the foil mesh 2071 at the location on the mesh immediately underlying the touch location. More specifically, contact of the user's finger with the display window 209 has the effect of reducing capacitive coupling between adjacent wires of the foil mesh 2071 underlying the contact location; this corresponds to a mutual capacitance mode of operation of the touch sensor 207. This change in capacitive coupling is detected by the touch-sensing control electronics section 2052. The nature of the touch input may be determined by the touch-sensing control electronics section 2052; for example, the touch sensing control electronics may identify whether the user's finger slides over the outward-facing surface 2091 of the display window 209 or engages with the surface 2091 at a single point. The touch-sensing control electronics section 2052 may generate an output signal in response to and dependent on the nature of the touch input. This output signal may be communicated to one or both of the lighting control electronics section 2051 and the heating control electronics section 2053. Where the output signal is conveyed to the lighting control electronics section 2051, the lighting control electronics section may generate a light emission 2062 from the light emitting elements 2061. The nature of the light emission 2062 (for example, colour, luminance, duration or periodicity of the light emission) may be dependent on the nature of the touch input. Where the output signal is conveyed to the heating control electronics section 2053, the heating control electronics section may act to initiate or pause the flow of current to the inductor coil 208 of the aerosol-generating device 2.

FIG. 8 illustrates an embodiment in which the touch sensor 207 is coupled to the control board assembly 4 of FIG. 3D, but without the presence of a light guide assembly 211. For the embodiment of FIG. 8, the foil mesh 2071 of the touch sensor 207 is preformed into a convex profile prior to the ZIF connector 2072 of the touch sensor being connected to ZIF connector 404 of the first control board 401. The curvature of the convex profile of the foil mesh 2071 generally corresponds to the curvature of the inward-facing surface 2092 of the display window 209 and/or the inner surface of the cylindrical elongate housing 201 of the aerosol-generating device 2.

FIGS. 9A to 9E are provided to help illustrate a second exemplary method of assembly of the aerosol-generating device 2.

FIG. 9A shows the control board assembly 4 of FIGS. 3C and 3D preinstalled inside the elongate tubular housing 201 at a position adjacent to and under the aperture 210 defined in the housing. The display window 209 has not yet been installed in the aperture 210. Also shown in FIG. 9A is the light guide assembly 211 and touch sensor 207. In the state shown in FIG. 9A, the light guide assembly 211 and touch sensor 207 are uncoupled from each other and from the control board assembly 4.

As shown in FIG. 9B, the light guide assembly 211 is inserted into or dropped through the aperture 210 so as to overlie the lighting assembly 206. FIG. 9C shows the light guide assembly 211 after insertion and positioning over the lighting assembly 206.

FIG. 9C also shows that after insertion and positioning of the light guide assembly 211, the touch sensor 207 is then inserted into or dropped through the aperture 210 so that the foil mesh 2071 of the touch sensor 207 is arranged over and in contact with the convex outward-facing surface 2112 of the light guide assembly 211. The cable 2073 is of sufficient length such that, prior to insertion of the foil mesh 2071 through the aperture 210, the ZIF connector 2072 of the touch sensor 207 is able to be connected to the ZIF connector 404 of the first control board 401. FIG. 9D shows the touch sensor 207 after insertion and positioning over the light guide assembly 211. In other embodiments, the light guide assembly 211 and touch sensor 207 may be pre-assembled outside of the housing 201 to form a combined assembly module, with the combined assembly module inserted into or dropped through the aperture 210 to couple with the control board assembly 4.

FIG. 9D also shows the installation of the display window 209 in the aperture 210, with FIG. 9E showing the assembled aerosol-generating device 2 after installation of the display window 209 in the aperture 210.

As can be understood from comparison of FIGS. 9E and 6G, the first and second methods of assembly (“slide-inside” and “drop-in” respectively) are able to result in the same configuration of the aerosol-generating device.

FIG. 10A shows a first embodiment of a lighting system 6 prior to assembly. The lighting assembly has a plurality of LEDs 61 and an opaque shield 62. The plurality of LEDs 61 are grouped in a plurality of lighting areas 611. For the embodiment of FIG. 10A, there are seven lighting areas 611a-g, each lighting area having a single one of the LEDs 61. In other examples, there may be a plurality of LEDs 61 per lighting area 611; for example, there may be 2, 3, 4 or more LEDs 61 per lighting area. The opaque shield 62 is formed of plastic; however, it will be appreciated that other materials may be used which are non-transmissive to the passage of light. The opaque shield 62 is formed with a plurality of apertures 63. The plurality of apertures 63 are grouped in a plurality of aperture areas 631. For the embodiment of FIG. 10A, there are seven aperture areas 631a-g. The apertures 63 of each aperture area 631a-g are arranged in co-linear relationship with each other, with each aperture area having a line of three apertures in this example. In another example, each aperture area may have a plurality of lines of apertures (for example, 2, 3, 4 or more lines), each line of apertures comprising 2, 3, 4, or more apertures. The aperture areas are positioned relative to each other so as to define the shape of the number ‘8’.

FIG. 10B shows the lighting system 6 in an assembled state, in which the opaque shield 62 is positioned over the plurality of LEDs 61. The aperture areas 631a-g are arranged across the area of the opaque shield 62 such that in the assembled state, each one of the aperture areas 631a-g overlies a corresponding single one of the lighting areas 611a-g. So, in use of the lighting system 6, light from the single LED 61 of lighting area 611a is visible through the three apertures 63 of aperture area 631a; the same correspondence applies to each of the remaining lighting areas 611b-g and aperture areas 631b-g. The LEDs 61 of the plurality of lighting areas 611a-g are designed to be driven by control electronics (for example, the lighting control electronics section 2051 described above). By selectively activating different ones of the lighting areas 611a-g alone or in combination with each other, the lighting system 6 is able to generate light emissions defining the form of different numbers, letters or shapes.

FIG. 11A shows a second embodiment of a lighting system 6′ prior to assembly. The lighting assembly 6′ has a plurality of LEDs 61 and an opaque shield 62′. The plurality of LEDs 61 are grouped in a plurality of lighting areas 611′a-h. The lighting area 611′h of LEDs 61 forms a first set 6111 of the plurality of lighting areas and is generally in the shape of an oval ring. The lighting areas 611a-g of LEDs 61 form a second set 6112 of the plurality of lighting areas and is generally in the form of an oval. As can be seen from FIG. 11A, the first set 6111 surrounds the second set 6112. Each of lighting areas 611′a-g has two LEDs 61. The plurality of apertures 63 of the opaque shield 62′ are grouped in a plurality of aperture areas 631′. For the embodiment of FIG. 11A, there are eight aperture areas 631′a-h. The aperture area 631h forms a first set 6311 of the plurality of aperture areas and is generally in the shape of an oval ring. The aperture areas 631′a-g form a second set 6312 of the plurality of aperture areas. The apertures 63 of aperture areas 631′a-g are arranged in two parallel lines of three apertures 63. The second set 6312 of aperture areas are positioned relative to each other so as to define the shape of the number ‘8’.

FIG. 11B shows the lighting system 6′ in an assembled state, in which the opaque shield 62′ is positioned over the plurality of LEDs 61. The aperture areas 631′a-h are arranged across the area of the opaque shield 62′ such that in the assembled state, each one of the aperture areas 631′a-h overlies a corresponding single one of the lighting areas 611′a-h. So, in use of the lighting system 6′, light from the two LEDs of lighting area 611′a is visible through the six apertures 63 of aperture area 631′a; the same correspondence applies to each of the remaining lighting areas 611′b-h and aperture areas 631′b-h. The LEDs of the plurality of the lighting areas 611′a-h are designed to be driven by control electronics (for example, the lighting control electronics section 2051 described above). The LEDs 61 forming the first set 6111 of the plurality of lighting areas may be controlled to all be activated simultaneously, thereby illuminating to define the shape of an oval ring. Alternatively, the control electronics may instead activate only a subset of the LEDs 61 of the first set 6111. By selectively activating different ones of the lighting areas 611′b-g, which make up the second set 6112, alone or in combination with each other, the lighting system 6′ is able to generate a light emission defining the form of different numbers, letters or shapes. Where the lighting system 6′ is installed in an aerosol-generating device (such as device 2 discussed above), the control electronics may be configured to selectively activate one of the first and second sets 6111, 6112 of lighting areas 611′a-h to generate a first light emission corresponding to a first state of the device 2, and to selectively activate the other of the first and second sets of lighting areas to generate a second light emission corresponding to a second state of the device. The first and second light emissions may be different to each other; for example, in one or more of colour, luminance, duration, periodicity. The first and second states may correspond to any given state of the device 2. By way of example, the first and second states may include: a) the power source 204 of the aerosol-generating device 2 containing sufficient energy to complete a single usage session; b) the power source 204 containing sufficient energy to complete two, three or more usage sessions; c) the power source 204 containing a level of energy below a predetermined threshold level of energy; d) selection or activation of one of a first predetermined thermal profile and a second predetermined thermal profile, in which each of the first and second predetermined thermal profiles define a heating profile for heating of the aerosol-forming substrate 302 by an electrical heating arrangement (for example, inductor coil 208) over a usage session, the first and second predetermined thermal profiles being different to each other; e) the aerosol-generating device 2 being in one of a pause mode state or a reactivation state; f) selection or activation of a change in operational state of the aerosol-generating device 2; g) progression through a usage session; h) progression through a pre-heating phase in which an electrical heating arrangement (for example, inductor coil 208) is heated to a predetermined target temperature; i) the aerosol-generating device being in a locked state in which the device is prohibited from generating aerosol; j) the aerosol-generating device being in an unlocked state in which the device is permitted to generate aerosol; k) a PIN number for unlocking the device such that it is permitted to generate aerosol; l) a type of a plurality of aerosol-generating articles being detected by the device; m) the aerosol-generating device being too hot to permit aerosol-generation; and n) the aerosol-generating device being too cold to permit aerosol-generation.

FIG. 12 shows a schematic cross-sectional illustration of an embodiment of the aerosol-generating device 2′ incorporating the lighting system 6 of FIG. 10. The embodiment of FIG. 12 includes all of the features of the aerosol-generating device shown in FIG. 6H. As can be seen in FIG. 12, the LEDs 61 of the lighting system 6 are arranged on surface 4011 of the first control board 401. The opaque shield 62 of the lighting system 6 is arranged between the LEDs 61 and light guide assembly 211. In an alternative embodiment, the opaque shield 62 may instead be overlaid on the outward-facing surface 2112 of the light guide assembly 211. In a further alternative embodiment, the opaque shield 62 may be incorporated into the structure of the display window 209.

FIG. 13 shows a plan view of a display window 209 of an aerosol-generating device 2, in which the display window overlies the lighting system 6′ of FIG. 11. FIG. 13 represents a state in which all of the LEDs 61 are activated, resulting in the first set 6111 (i.e. lighting area 611′h) illuminating through the first set 6311 of aperture area 631′h to define the shape of an illuminated oval, and the second set 6112 of lighting areas 611′a-g illuminating through the second set 6312 of aperture areas 631′a-g to define the shape of an illuminated figure ‘8’. It will be appreciated that the presence of the foil mesh 2071 of touch sensor 207 under the display window 209 also permits the outward-facing surface of the display window to also serve as a touch interface for a user's finger(s).

FIG. 14 is a schematic representation of an exemplary embodiment of the touch-sensing control electronics section 2052 for controlling operation of the capacitive touch sensor 207 of the aerosol-generating device 2 illustrated in the above figures. The touch sensing control electronics section 2052 is shown in broken outline in FIG. 14. The touch sensing control electronics section 2052 has a microcontroller 251 containing a processor 252, memory 253 and input-output means 254. The touch sensing control electronics section 2052 also has a touch sensor driver 255. The touch sensor driver 255 is separate to the microcontroller 251 but communicably coupled thereto via the input-output means 254. The touch sensor driver 255 is also communicably coupled to the touch sensor 207. The touch sensor driver 255 detects a touch event based on electrical signals from the touch sensor 207 in response to occurrence of the touch event; the touch event might be a user's finger having contacted the outward-facing surface 2091 of the display window 209. After determining the occurrence of the touch event, the touch sensor driver 255 sends one or more data signals to the microcontroller 251 via the input-output means 254, the data signals being indicative of the occurrence of the touch event. After the microcontroller 251 receives the data signals, the processor 252 accesses instructions contained in the memory 253 and generates one or more control signals for communicating to one or more of the lighting control electronics section 2051, the heating control electronics section 2053 and other control electronics sections of the aerosol-generating device 2. In this manner, the occurrence of a touch event on the display screen 209 is able to result in one or more control inputs to control one or more of the lighting assembly 206 (or the lighting system 6, 6′), the inductor coil 208 and other features of the aerosol-generating device 2.

FIG. 15 is a schematic representation of an alternative exemplary embodiment of the touch-sensing control electronics section 2052 for controlling operation of the capacitive touch sensor 207 of the aerosol-generating device 2. This embodiment differs from the embodiment of FIG. 14 in that the microcontroller 251 contains touch sensing circuitry 255′, rather than using a separate touch sensor driver 255. The touch sensing circuitry 255′ detects a touch event based on electrical signals received from the touch sensor 207 (via the input-output means 254) in response to occurrence of the touch event; again, the touch event might be a user's finger having contacted the outward-facing surface 2091 of the display window 209. After determining the occurrence of the touch event, the touch sensing circuitry 255′ outputs a signal to the processor 252 via the input-output means 254, the signal being indicative of the occurrence of the touch event. The processor 252 then accesses instructions contained in the memory 253 and generates one or more control signals for communicating to one or more of the lighting control electronics section 2051, the heating control electronics section 2053 and other control electronics sections of the aerosol-generating device 2. In this manner, the occurrence of a touch event on the display screen 209 is able to result in one or more control inputs to control one or more of the lighting assembly 206 (or lighting system 6), the inductor coil 208 and other features of the aerosol-generating device 2. Although not shown in FIG. 15, the touch sensing circuitry 255′ may include a sampling capacitor, with the touch sensing circuitry outputting the signal indicative of a touch event by charging a sampling capacitor to a voltage indicative of the touch event.

FIG. 16 is a schematic representation of an exemplary embodiment of the lighting control electronics section 2051 for controlling operation of the lighting assembly 206 of the aerosol-generating device 2 illustrated in the above figures. The lighting control electronics section 2051 is shown in broken outline in FIG. 16. The lighting control electronics section 2051 has a microcontroller 261 containing a processor 262, memory 263 and input-output means 264. The lighting control electronics section 2051 also has an LED driver 265. The LED driver 265 is separate to the microcontroller 261 but communicably coupled thereto via the input-output means 264. The LED driver 265 is also communicably coupled to the LEDS 2061 of the lighting assembly 206 so as to control the LEDs. As previously discussed, the lighting control electronics section 2051 may be communicably coupled to the touch sensing control electronics section 2052, so that the LED driver 265 may control the LEDs 2061 of the lighting assembly 206 in response to a touch event being detected by the touch sensing control electronics section 2052.

FIG. 17 is a schematic representation of an alternative exemplary embodiment of the lighting control electronics section 2051 for controlling operation of the lighting assembly 206 of the aerosol-generating device 2. This embodiment differs from the embodiment of FIG. 16 in that the LED driver 265 is integrated into the microcontroller 261, rather than being separate therefrom. The LED driver 265 controls the LEDs 2061 of the lighting assembly 206 via the input-output means 264. The LED driver 265 may control the LEDs 2061 of the lighting assembly 206 in response to a touch event being detected by the touch sensing control electronics section 2052.

FIG. 18 is a schematic representation illustrating how the LEDs 2061 of the lighting assembly 206 may be coupled to an arrangement 8 of intersecting row pins 81 and column pins 82. As can be seen, a single LED 2061 is coupled to the intersection of each rod pin 81 and column pin 82. When used in combination with the lighting control electronics sections 2051 of FIG. 16 or 17, the LED driver 265 operates to illuminate each one of the plurality of LEDs 2061 by activating the row pin 81 and the column pin 82 to which the respective LED is connected. The LED driver 265 may operate to activate a single one of the LEDs 2061 or any combination of multiple ones of the LEDs.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number “A” is understood as “A”±10% of “A”. Within this context, a number “A” may be considered to include numerical values that are within general standard error for the measurement of the property that the number “A” modifies. The number “A”, in some instances as used in the appended claims, may deviate by the percentages enumerated above provided that the amount by which “A” deviates does not materially affect the basic and novel characteristic(s) of the claimed invention. Also, all ranges include the maximum and minimum points disclosed and include any intermediate ranges therein, which may or may not be specifically enumerated herein. The terms “in which” and “wherein” are used synonymously through this specification.

1.-15. (canceled)

16. An aerosol-generating system, comprising:
a housing, wherein an arcuate portion of the housing comprises an arcuate outer surface; and
a touch sensor comprising at least one arcuate layer, wherein a curvature of the at least one arcuate layer at least partially conforms with a curvature of the arcuate outer surface of the arcuate portion of the housing,
wherein the at least one arcuate layer is arranged within the housing such that an outward-facing surface of the at least one arcuate layer opposes an inner surface of the arcuate portion of the housing.

17. The aerosol-generating system according to claim 16, further comprising control electronics coupled to the touch sensor and configured to receive an input from the touch sensor associated with a touch event.

18. The aerosol-generating system according to claim 16, further comprising a display window having an arcuate outer surface.

19. The aerosol-generating system according to claim 18, wherein a curvature of the arcuate outer surface of the display window at least partially conforms with a curvature of the arcuate outer surface of the arcuate portion of the housing.

20. The aerosol-generating system according to claim 19, wherein the arcuate outer surface of the display window is flush with the arcuate outer surface of the arcuate portion of the housing.

21. The aerosol-generating system according to claim 19, wherein the display window is installed in an aperture defined in the arcuate portion of the housing, the display window thus forming part of the housing.

22. The aerosol-generating system according to claim 18, further comprising a lighting assembly comprising one or more light emitting elements, the lighting assembly being arranged within the housing and configured to transmit light through the display window.

23. The aerosol-generating system according to claim 22, wherein the lighting assembly further comprises a substantially planar surface having the one or more light emitting elements arranged thereon.

24. The aerosol-generating system according to claim 16, wherein the inner surface of the arcuate portion of the housing comprises an arcuate inner surface, the arcuate inner and outer surfaces of the arcuate portion of the housing having complementary curvatures.

25. The aerosol-generating system according to claim 24, wherein a thickness of the arcuate portion of the housing, measured between the arcuate inner and outer surfaces of the arcuate portion of the housing, is uniform at least where the outward-facing surface of the at least one arcuate layer opposes the arcuate inner surface of the arcuate portion of the housing.

26. The aerosol-generating system according to claim 16, wherein the arcuate portion of the housing further comprises a dielectric material.

27. The aerosol-generating system according to claim 16, wherein the arcuate outer surface of the arcuate portion of the housing defines a touch interface for a user's finger.

28. The aerosol-generating system according to claim 16, further comprising a support member arranged within the housing, the at least one arcuate layer arranged over and supported on an arcuate outward-facing surface of the support member.

29. The aerosol-generating system according to claim 28, wherein opposing surfaces of the at least one arcuate layer are disposed between and in surface contact with the arcuate outward-facing surface of the support member and an arcuate inner surface of the arcuate portion of the housing.

30. The aerosol-generating system according to claim 28, wherein the support member comprises a light guide assembly configured to guide light to the arcuate outward-facing surface of the support member.

31. The aerosol-generating system according to claim 16, wherein the at least one arcuate layer is configured to be transmissive to the passage of light between opposing surfaces of the at least one arcuate layer.
